(19) United States
(12) Patent Application Publication
(10) Pub. No.: US 2014/0289474 A1
(43) Pub. Date: Sep. 25, 2014

(54) OPERATION PROCESSING APPARATUS, INFORMATION PROCESSING APPARATUS AND METHOD OF CONTROLLING INFORMATION PROCESSING APPARATUS

(71) Applicant: FUJITSU LIMITED, Kawasaki-shi (JP)

(72) Inventors: Takahiro Aoyagi, Fostercity, CA (US); Yoshiro Ikeda, Kawasaki (JP)

(73) Assignee: FUJITSU LIMITED, Kawasaki-shi (JP)

(21) Appl. No.: 14/195,966

(22) Filed: Mar. 4, 2014

(30) Foreign Application Priority Data
Mar. 25, 2013 (JP) 2013-062812

(51) Int. Cl. G06F 12/08

(52) U.S. Cl. CPC G06F 12/0815; G06F 12/0891; G06F 12/0811
USPC 711/133; 711/143

(57) ABSTRACT

An operation processing apparatus connected with another operation processing apparatus includes an operation processing unit configured to perform an operation process using first data administered by the own operation processing apparatus and second data administered by another operation processing apparatus and acquired from another operation processing apparatus, and a control unit configured to include a setting unit which sets the operation processing unit to an operating state or a non-operating state and a cache memory which holds the first data and the second data, wherein when the setting unit sets the operation processing unit to the operating state and the second data is evicted from the cache memory, the control unit sends to another operation processing apparatus the evicted data and a request which is a trigger for storing the evicted data in a cache memory in another operation processing apparatus.

### CROSS-REFERENCE TO RELATED APPLICATION

This application is based upon and claims the benefit of priority of the prior Japanese Patent Application No. 2013-062812, filed on Mar. 25, 2013, the entire contents of which are incorporated herein by reference.

### FIELD

The embodiments described herein are related to an operation processing apparatus, an information processing apparatus and a method of controlling an information processing apparatus.

### BACKGROUND

An operation processing apparatus is applied to practical use for sharing data stored in a main memory among a plurality of processor cores in an information processing apparatus. Plural pairs of a processor core and an L1 cache form a group of processor cores in the information processing apparatus. A group of processor cores is connected with an L2 cache, an L2 cache control unit and a main memory. A set of the group of processor cores, the L2 cache, the L2 cache control unit and the main memory is referred to as cluster.

A cache is a storage unit with small capacity which stores data used frequently among data stored in a main memory with large capacity. When data in a main memory is temporarily stored in a cache, the frequency of access to the main memory, which is time-consuming, is reduced. The cache employs a hierarchical structure in which processing at higher speed is achieved in a higher level and larger capacity is achieved in a lower level.

In a directory-based cache coherence control scheme, the L2 cache as described above stores data requested by the group of processor cores in the cluster to which the L2 cache belongs. The group of processor cores is configured to acquire data more frequently from an L2 cache closer to the group of processor cores. In addition, data stored in a main memory is administered by the cluster to which the main memory belongs in order to maintain the data consistency.

Further, the cluster administers in what state data in the main memory to be administered is and in which L2 cache the data is stored according to this scheme. Moreover, when the cluster receives a request to the main memory for acquiring data, the cluster performs appropriate processes for the data acquisition request based on the current state of the data. And then the cluster performs the processes for the data acquisition request and updates the information related to the state of the data.

As illustrated in Patent Document 1, a proposal is offered for reducing the latency required for an access to a main memory in an operation processing apparatus employing the above cluster structure and the above processing scheme. In Patent Document 1, when cache miss occurs and the cache does not have capacity available for storing data, data in the main memory in the cluster to which the cache belongs is preferentially swept from the cache to create available capacity.

### [Patent Document]

[Patent document 1] Japanese Laid-Open Patent Publication No. 2000-66955

### SUMMARY

According to an aspect of the embodiments, it is provided an operation processing apparatus connected with another operation processing apparatus, including an operation processing unit configured to perform an operation process using first data administered by the own operation processing apparatus and second data administered by another operation processing apparatus and acquired from another operation processing apparatus, and a control unit configured to include a setting unit which sets the operation processing unit to an operating state or a non-operating state and a cache memory which holds the first data and the second data, wherein when the setting unit sets the operation processing unit to the operating state and the second data is evicted from the cache memory, the control unit sends to another operation processing apparatus the evicted data and a request which is a trigger for storing the evicted data in a cache memory in another operation processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a part of a cluster configuration in an information processing apparatus according to a comparative example;

FIG. 2 is a diagram schematically illustrating a configuration of an L2 cache control unit according to the comparative example;

FIG. 3 is a diagram illustrating processes when a data acquisition request is generated in a cluster according to the comparative example;

FIG. 4 is a diagram illustrating processes performed in the L2 cache control unit in the processing example as illustrated in FIG. 3;

FIG. 5 is a diagram illustrating processes when a data acquisition request is generated in the cluster according to the comparative example;

FIG. 6 is a diagram illustrating processes performed in the L2 cache control unit in the comparative example as illustrated in FIG. 5;

FIG. 7 is a diagram illustrating processes performed in clusters when a Flush Back process and a Write Back process for data are performed in the comparative example;

FIG. 8 is a diagram illustrating an example of processes performed in the L2 cache control unit in the process example as illustrated in FIG. 7;

FIG. 9 is a diagram illustrating an example of processes for exclusively acquiring data in the information processing apparatus in the comparative example;

FIG. 10 is a diagram illustrating processes performed in the L2 cache control unit in the process example as illustrated in FIG. 9;

FIG. 11 is a diagram schematically illustrating a part of a cluster configuration in an information processing apparatus according to an embodiment;

FIG. 12 is a diagram illustrating an L2 cache control unit in a cluster according to the embodiment;

FIG. 13 is a diagram illustrating an operating mode of a group of processor cores in clusters in a “mode on” state in the information processing apparatus according to the embodiment;

FIG. 14 is a diagram illustrating processes performed when data is evicted from an L2 cache belonging to a cluster which is Local in the embodiment;

FIG. 15 is a diagram illustrating processes performed by the L2 cache control unit in the process example as illustrated in FIG. 14;

FIG. 16 is a diagram illustrating a circuit which forms the controller in the process example as illustrated in FIG. 14;

FIG. 17 is a diagram illustrating a circuit which forms the controller in the process example as illustrated in FIG. 14;

FIG. 18 is a timing chart for the L2 cache control unit in the process example as illustrated in FIGS. 14 to 17;

FIG. 19 is a diagram illustrating processes performed when a cluster which is Local acquires data from a main memory in a cluster which is Home;

FIG. 20 is a diagram illustrating processes performed in the L2 cache control unit in the process example as illustrated in FIG. 19;

FIG. 21 is a diagram illustrating a circuit which forms a controller in the process example as illustrated in FIG. 19;

FIG. 22 is a diagram illustrating an example in which clusters form a plurality of groups in the information processing apparatus according to the embodiment;

FIG. 22 is a timing chart for the L2 cache control unit in the process example as illustrated in FIGS. 19 to 22;

FIG. 23 is a diagram illustrating a variation of a circuit included in the controller according to the embodiment; and

FIG. 25 is a diagram illustrating an example of a configuration of the L2 cache control unit according to the embodiment.

### DESCRIPTION OF EMBODIMENTS

In the above described technologies, a process for accessing a main memory to write back data to the memory is performed because cache is temporary storage. A main memory is large capacity and may be mounted on a chip different from a chip for a group of processor cores and a cache. Thus, an access to a main memory can be a bottleneck for reducing data access latency. Thus, it is an object of one aspect of the technique disclosed herein to provide an operation processing apparatus, information processing apparatus and a method of controlling an information processing apparatus to reduce the access frequency to a main memory. First, a comparative example of an information processing apparatus according to one embodiment is described with reference to the drawings.

### Comparative Example

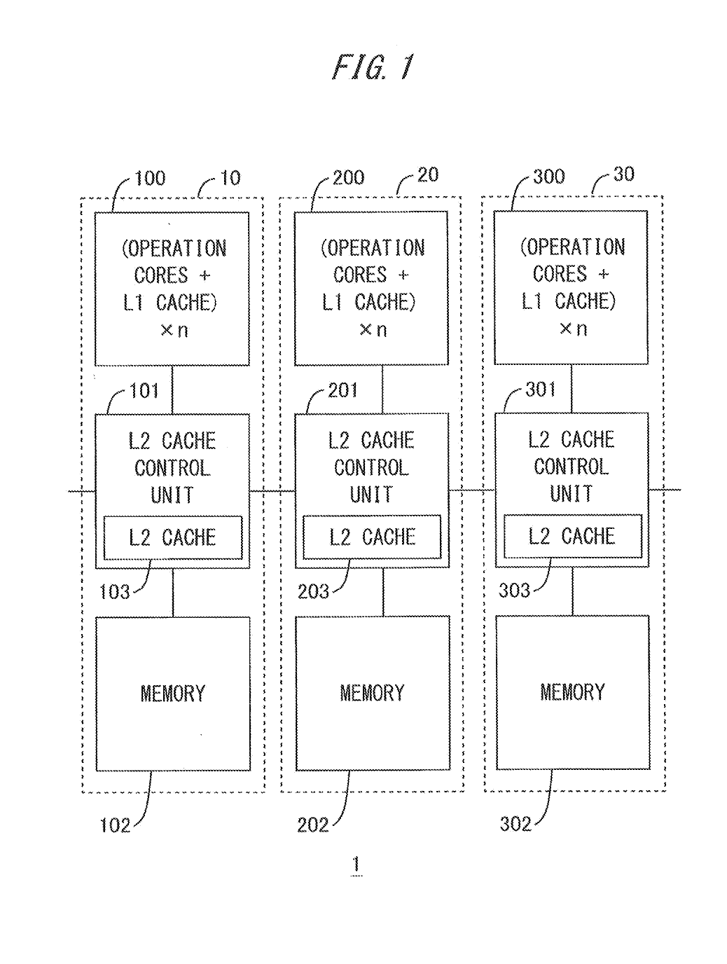

FIG. 1 illustrates a part of a cluster configuration in an information processing apparatus according to the comparative example. As illustrated in FIG. 1, a cluster 10 includes a group of processor cores 100 which include n (n is a natural number) combinations of a processor core and an L1 cache, an L2 cache control unit 101 and a memory 102. The L2 cache control unit 101 includes an L2 cache 103. Similar to the cluster 10, clusters 20 and 30 also include groups of processor cores 200 and 300, L2 cache control units 201 and 301, memories 202 and 302, and L2 caches 203 and 303 respectively.

In the following descriptions, a cluster to which a processor core requesting data stored in a main memory belongs is referred to as Local (cluster). In addition, a cluster to which the main memory storing the requested data belongs is referred to as Home (cluster). Further, a cluster which is not Local and holds the requested data is referred to as Remote (cluster). Therefore, each cluster can be Local, Home and/or Remote according to where data is requested to or from. Moreover, a Local cluster also functions as Home in some cases for performing processes related to a data acquisition request. And a Remote cluster also functions as Home in some cases. Additionally, the state information of data stored in a main memory administered by a Home cluster is referred to as directory information. The details of the above components are described later.

As illustrated in FIG. 1, an L2 cache control unit in each cluster is connected with another L2 cache control unit via a bus or an interconnect. In the information processing apparatus 1, since the memory space is so-called flat, it is uniquely determined by physical addresses which data is stored in a main memory and which cluster the main memory belongs to.

For example, when the cluster 10 acquires data stored not in the memory 102 but in the memory 202, the cluster 10 sends a data request to the cluster 20, to which the memory 202 storing the data belongs. The cluster 20 checks the state of the data. Here, the state of data means the status of use of the data such as in which cluster the data is stored, whether or not the data is being exclusively used, and in what state the synchronization of the data is in the information processing apparatus 1. In addition, when the data to be acquired is stored in the L2 cache 203 belonging to the cluster 20 and the synchronization of the data is established in the information processing apparatus 1, the cluster 20 sends the data to the cluster 10 requesting the data. And then the cluster 20 records in the state information of the data that the data is sent to the cluster 10 and the data is synchronized in the information processing apparatus 1.

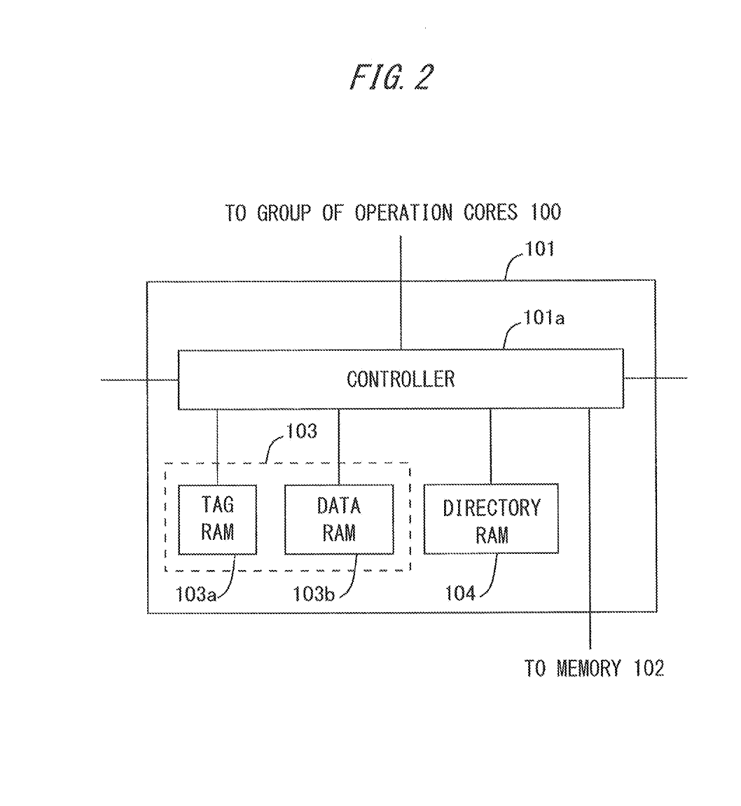

FIG. 2 schematically illustrates a configuration of the L2 cache control unit 101. The L2 cache control unit 101 includes a controller 101a, an L2 cache 103 and a directory RAM 104. In addition, the L2 cache 103 includes a tag RAM 103a and a data RAM 103b. The tag RAM 103a holds tag information of blocks held by the data RAM 103b. The tag information means information related to the status of use of each data, addresses in a main memory and the like in the coherence protocol control. In a multiple processor environment, in which a plurality of processors are used, it is more likely that processors share the same data and access to the data. Therefore, the consistency of data stored in each cache is maintained in the multiple processor environment. A protocol for maintaining the consistency of data among processors is referred to as coherence protocol. MESI protocol is one example of such a protocol. In the following descriptions, MESI protocol, which administers the status of use of data with four states, Modified, Exclusive, Shared and Invalid, is used. However, available protocols are not limited to this protocol.

The controller 101a uses the tag RAM 103a to check in which state a memory block is stored in the data RAM 103b and the presence of data. The data RAM 103b is a RAM for holding a copy of data stored in the memory 102, for example. The directory RAM 104 is a RAM for handling the directory information of a main memory which belongs to a Home cluster. Since the directory information is a large amount of information, the directory information is stored in a main memory and a cache for the main memory is arranged in the RAM in many cases. However, the directory information of the main memory which belongs to the Home cluster is stored in the directory RAM 104 in the present embodiment.

The controller 101a accepts requests from the group of processor cores 100 or controllers in L2 cache control units in other clusters. The controller 101a sends operation requests to the tag RAM 103a, the data RAM 103b, the directory RAM 104, the memory 102 or other clusters according to the contents of received requests. And when the requested operations are completed, the controller 101a returns the operation results to the requestors of the operations.

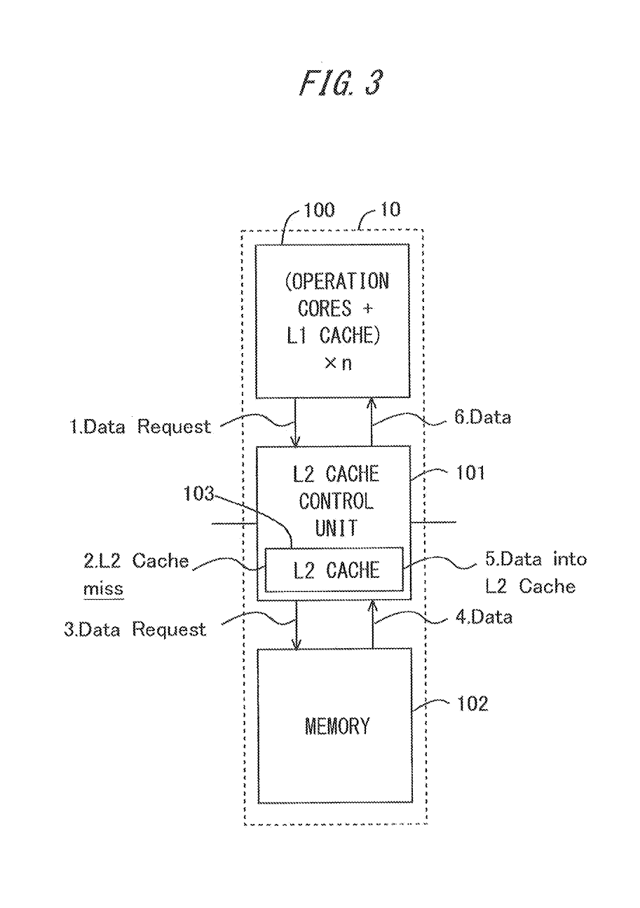

FIG. 3 is a diagram illustrating an example of processes performed when a data acquisition request is generated in the cluster 10. The cluster 10 is a Local cluster and a Home cluster in FIG. 3. FIG. 3 illustrates processes performed when a data acquisition request to the memory 102 which belongs to the cluster 10 is generated and cache miss occurs in the L2 cache 103. It is assumed here that the cache miss occurs in the L1 cache when the L2 cache control unit receives the data acquisition request.

A request of data is sent from a processor core in the cluster 10 which is Local to the L2 cache control unit 101. When the L2 cache control unit 101 in the cluster 10 which is also Home determines that the L2 cache 103 does not hold the data (miss), the L2 cache control unit 101 refers to the directory information stored in the directory RAM 104. And then the L2 cache control unit 101 checks based on the directory information to determine whether or not the data is held by an L2 cache in a Remote cluster. When the L2 cache control unit 101 determines that the L2 cache in the Remote cluster does not hold the data (miss), the L2 cache control unit 101 requests data acquisition to the memory 102 in the cluster 10 which is Local. When the memory 102 returns the data to the L2 cache control unit 101, the L2 cache control unit 101 stores the data in the data RAM 103b in the L2 cache 103. In addition, the L2 cache control unit 101 sends the data to the processor core requesting the data in the group of processor cores 100. Further, the tag RAM 103a in the L2 cache stores information indicating that the data is acquired in the state in which the data is synchronized in the information processing apparatus 1. Further, the directory RAM 104 stores information indicating that the data is held by the cluster 10 which is Local.

When the L2 cache control unit 101 refers to the tag RAM 103a to determine that the data RAM 103b in the L2 cache 103 does not have capacity for storing data, the L2 cache control unit 101 evicts data from the L2 cache 103 according to a predetermined algorithm including a random algorithm and LRU (Least Recently Used) algorithm. When the L2 cache control unit 101 refers to the tag RAM 103a to determine that the data to be evicted is in the state similar to the data stored in the memory 102, the L2 cache control unit 101 discards the data to be evicted. On the other hand, when the L2 cache control unit 101 refers to the tag RAM 103a to determine that the data to be evicted has been updated, the L2 cache control unit 101 writes back the data to be evicted to the memory 102.

Thus, the data requested by the processor core in the group of processor cores 100 is stored in free space in the data RAM 103b in the L2 cache 103. Additionally, when a processor core in the group of processor cores 100 generates a data acquisition request for the data again, the L2 cache control unit 101 holds the data stored in the data RAM 103b and sends the data to the processor core (hit). Therefore, as long as the data is not evicted from the data RAM 103b, the L2 cache control unit 101 does not access to the memory 102.

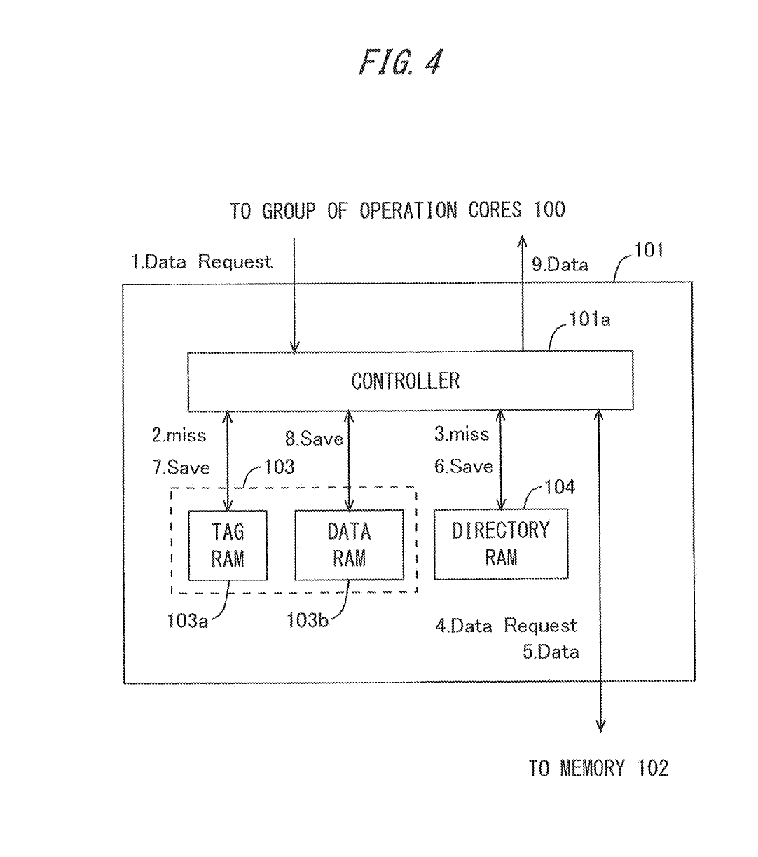

FIG. 4 is a diagram illustrating processes performed in the L2 cache control unit 101 in the process example as illustrated in FIG. 3. The controller 101a accepts a data acquisition request from a processor core in the group of processor cores 100. The data acquisition request contains the information indicating that the request is generated by the processor core, the type of the data acquisition request and the address in the main memory storing the data. The controller 101a initiates appropriate processes according to the contents of the request.

First, the controller 101a checks the tag RAM 103a to determine whether or not a copy of a block of a main memory which stores the data as the target of the data acquisition request is found in the data RAM 103b. When the controller 101a receives a result indicating that the copy is not found (miss) from the tag RAM 103a, the controller 101a refers to the directory RAM 104 to check whether or not the data as the target of the data acquisition request is held by Remote clusters. The controller 101a receives a result indicating that the data is not held by clusters (miss) from the directory RAM 104, the controller 101a sends a data acquisition request of the data to the memory 102. When the controller 101a receives the data from the memory 102, the controller 101a registers in the directory RAM 104 information indicating that the data is held by a Home cluster. In addition, the controller 101a stores information of the status of use of the data (“Shared” etc.) in the tag RAM 103a. Further, the controller 101a stores the data in the data RAM 103b. Moreover, the controller 101a sends the data to the processor core requesting the data in the group of processor cores 100.

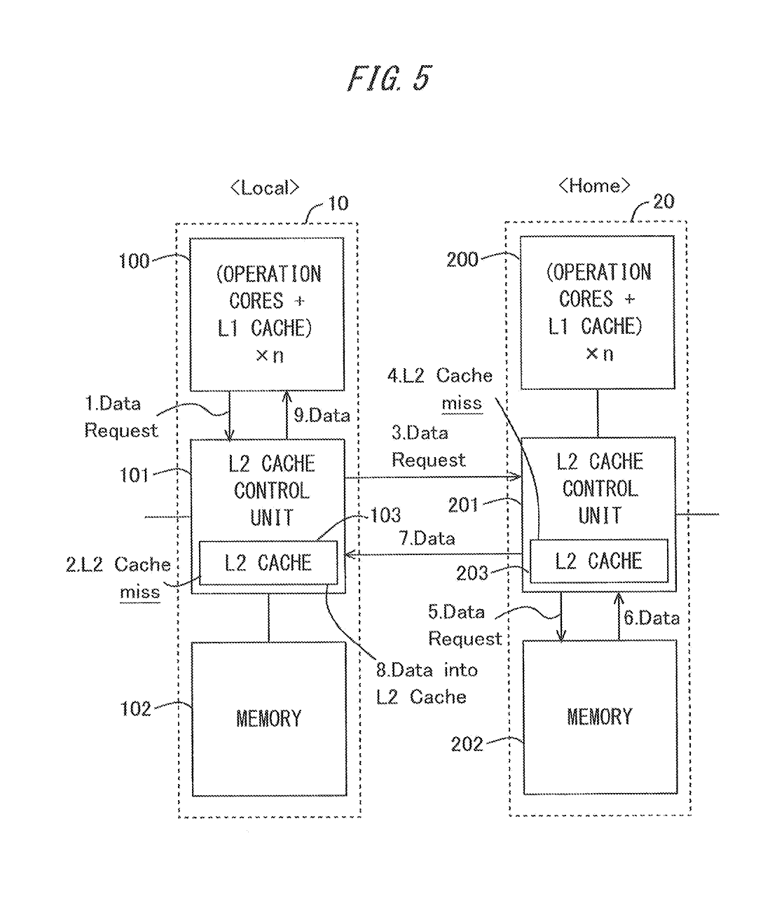

Next, FIG. 5 is a diagram illustrating an example of processes performed when a data acquisition request is generated in the cluster 10. In the example as illustrated in FIG. 5, the cluster 10 is a Local cluster and the cluster 20 is a Home cluster. A processor core in the group of processor cores 100 in the cluster 10 which is Local sends a data acquisition request to the L2 cache 103 in the cluster 10. And cache miss occurs (miss) because the requested data is not stored in the L2 cache 103. Thus, the cluster 10 sends a data acquisition request for the data to the cluster 20 which is Home. The L2 cache control unit 201 in the cluster 20 checks the directory information stored in the L2 cache 203. When the controller 201a in the L2 cache control unit 201 determines that the data is not stored in the L2 cache 203 and in L2 caches in Remote clusters (miss), the controller 201a sends a data acquisition request for the data to the memory 202.

When the memory 202 returns the data to the L2 cache control unit 201, the L2 cache control unit 201 updates the directory information stored in the directory RAM 204. And the L2 cache control unit 201 sends the data to the cluster 10 which is Local and requesting the data. The L2 cache control unit 101 in the cluster 10 stores in the L2 cache 103 the data received from the L2 cache control unit 201 in the cluster 20. And then the L2 cache control unit 101 sends the data to the processor core requesting the data in the group of processor cores 100.

Here, the data is not stored in the L2 cache 203 in the cluster 20 which is Home for the following reasons. First, the data is requested from a processor core in the cluster 10 which is Local and not requested from a processor core in the cluster 20 which is Home. Second, when the data is stored in the L2 cache 203 in the cluster 20 which is Home, this means that data which is not used by the group of processor cores 200 in the cluster 20 which is Home is stored in the L2 cache 203. Third, when such unused data is stored in the L2 cache 203, data used by the group of processor cores 200 may be evicted from the L2 cache 203.

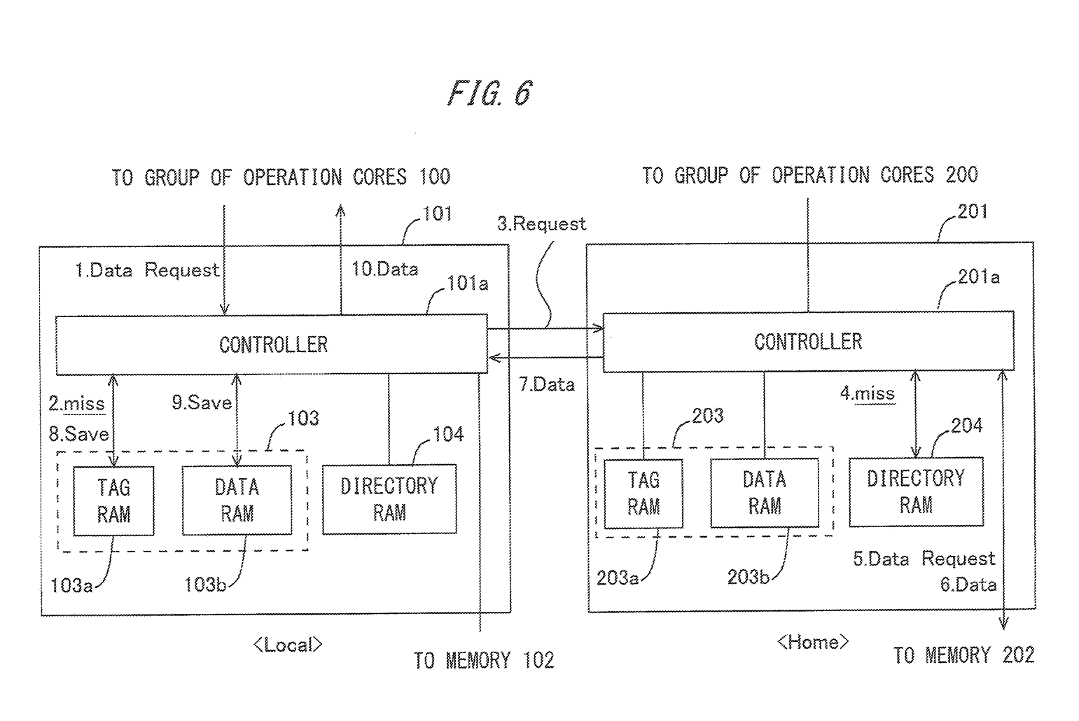

FIG. 6 is a diagram illustrating processes performed by the L2 cache control units 101 and 201 in the example as illustrated in FIG. 5. The controller 101a in the L2 cache control unit 101 in the cluster 10 which is Local accepts a data acquisition request from a processor core in the group of processor cores 100. The data acquisition request includes the information indicating that the request is generated by the processor core, the type of the data acquisition request and the address in the main memory storing the data. The controller 101a initiates appropriate processes according to the contents of the request.

The controller 101a checks the tag RAM 103a to determine whether or not a copy of a block of a main memory which stores data as the target of the data acquisition request is found in the data RAM 103b. When the controller 101a receives a result indicating that the copy is not found (miss) from the tag RAM 103a, the controller 101a sends a data acquisition request of the data to the controller 201a in the L2 cache control unit 201 which belongs to the cluster 20 which is Home.

When the controller 201a receives the data acquisition request, the controller 201a checks the directory RAM 204 to determine whether or not the data as the target of the data acquisition request is stored in an L2 cache in any cluster. When the controller 201a receives a result indicating that the data is not found in clusters (miss) from the directory RAM 204, the controller 201a sends a data acquisition request for the data to the memory 202. When the memory 202 returns the data to the controller 201a, the controller 201a stores as the status of use of the data in the directory RAM 204 the information indicating that the data is held by the cluster 10 requesting the data. And then the controller 201a sends the data to the controller 101a in the cluster 10 requesting the data. When the controller 101a in the cluster 10 receives the data, the controller 101a stores the status of use of the data (“Shared” etc.) in the tag RAM 103a. In addition, the controller 101a stores the data in the data RAM 103b. Further, the controller 101a sends the data to the processor core requesting the data in the group of processor cores 100.

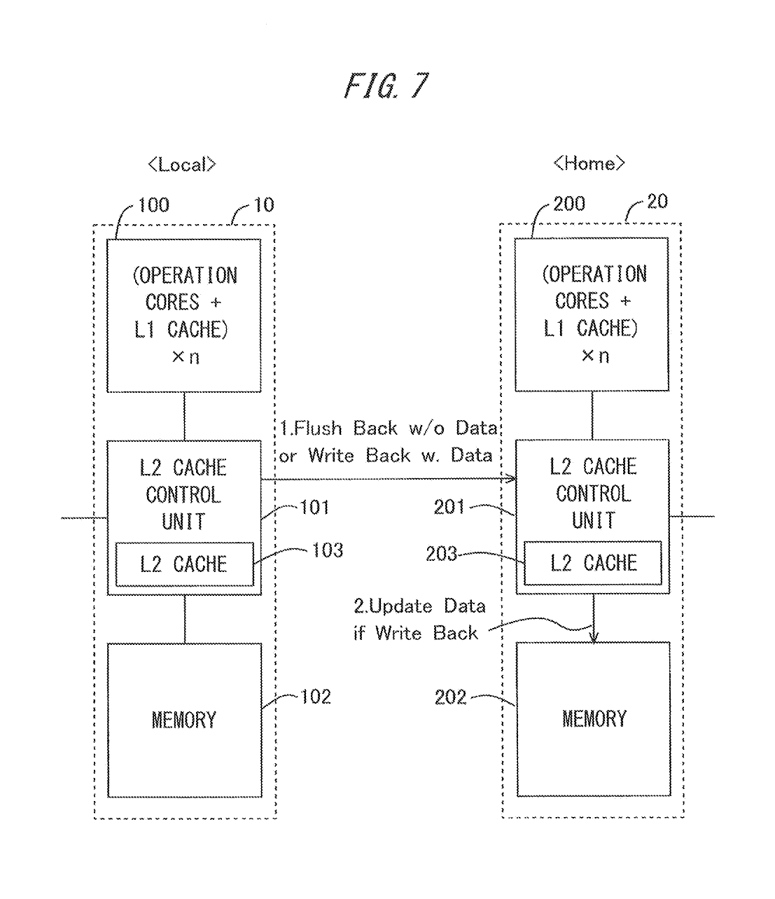

FIG. 7 is a diagram illustrating processes performed by clusters when Flush Back or Write Back for data to a Remote cluster is executed in the comparative example. Flush Back to a Remote cluster means processes performed when a cluster evicts from the cache the data acquired from another cluster. Flush Back also means processes for notifying the Home cluster that the data is evicted from the cluster which is not only Local but also Remote for the Home cluster when the evicted data is not updated and is synchronized in the information processing apparatus 1, that is, the evicted data is clean. The processes are performed for the Home cluster to update the directory information.

Moreover, Write Back to a Remote cluster means processes performed when a cluster evicts data acquired from another cluster from the cache in the cluster. Write Back also means processes for notifying another cluster that the data is so-called “dirty” when the evicted data is updated and is not synchronized in the information processing apparatus 1, that is, the evicted data is dirty. As described below, when a cluster executes Flush Back to a Remote cluster in the comparative example, the cluster sends a Flush Back request to the cluster from which the data is acquired and does not send the data to the cluster from which the data is acquired. To the contrary, when the cluster executes Write Back to a Remote cluster in the comparative example, the cluster sends a Write Back request to the cluster from which the data is acquired and also sends the data to the cluster from which the data is acquired so that the cluster from which the data is acquired stores the data in the main memory.

As described above, when new data is stored in an L2 cache and the L2 cache does not have capacity for the data, data stored in the L2 cache is evicted according to a predetermined algorithm. In FIG. 7, the cluster 10 is a Local cluster and the cluster 20 is a Home cluster. It is noted that the cluster 20 is also a Remote cluster in the example. Further, clusters in the information processing apparatus 1 which are not depicted in FIG. 7 are Remote. Moreover, in FIG. 7, the cluster 10 evicts the data to be stored in the memory 202 in the cluster 20 which is Remote among the data stored in the data RAM 103b since the data RAM 103b in the L2 cache 103 which belongs to the cluster 10 which is Local does not have data capacity.

In this case, as illustrated in FIG. 7, the L2 cache control unit 101 in the cluster 10 sends a request for evicting the data from the L2 cache 103 to the L2 cache control unit 201 in the cluster 20. This request is a Flush Back request or a Write Back request. It is noted that the Flush Back request and the Write Back request are examples of predetermined requests. In addition, when data to be evicted is clean, a Flush Back request is sent to the L2 cache control unit 201 in the cluster 20 which is Home. The L2 cache control unit 201 stores in the directory information in the L2 cache control unit 201 information indicating that the data is evicted from the cluster 10 requesting the data.

On the other hand, when the data to be evicted is dirty, a Write Back request and the data are sent to the L2 cache control unit 201 in the cluster 20 which is Home. For example, when data is updated by the group of processor cores 100 in the cluster 10 which is Local the data becomes dirty. In addition, the L2 cache control unit 201 stores in the directory information stored in the directory RAM 204 information indicating that the data is evicted from the cluster 10 requesting the data. The L2 cache control unit 201 writes back the data to the memory 202 which belongs to the cluster 20 which is Home. It is noted that a processor core in the cluster which is Remote requests the data to the cluster 20 which is Home. Namely, the data is not requested by the group of processor cores 200 in the cluster 20 which is Home. When the data is stored in the L2 cache 203 in the cluster 20 which is Home, other data which the group of processor cores 200 requests may be evicted from the L2 cache 203. Therefore, the data is not stored in the L2 cache 203 in the cluster 20 which is Home.

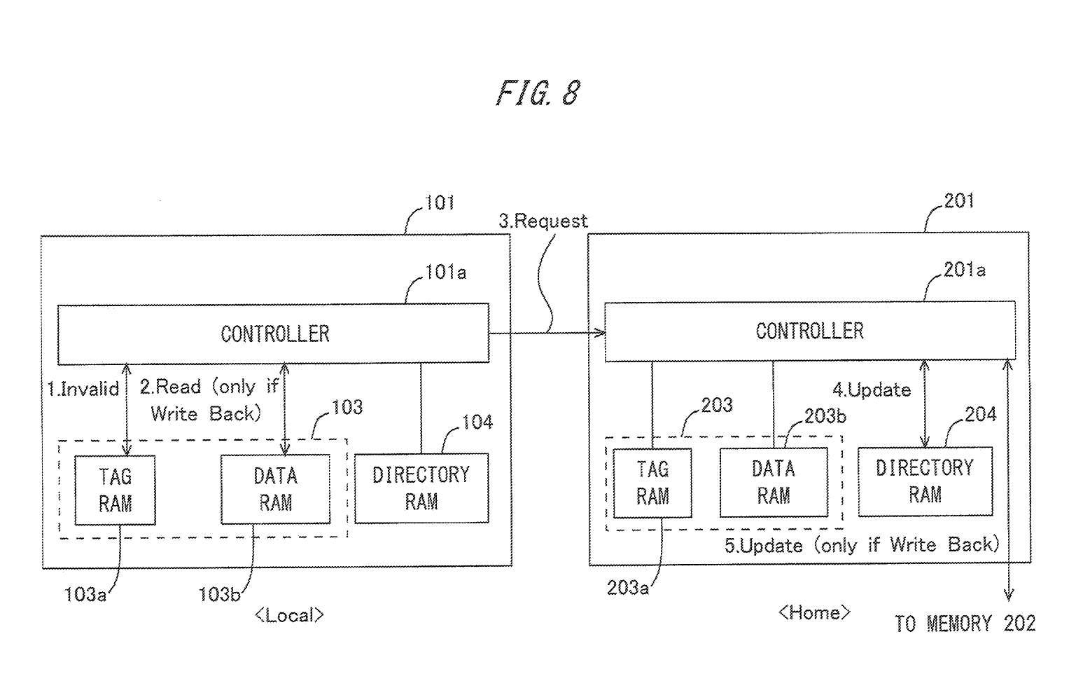

FIG. 8 is a diagram illustrating processes performed in the L2 cache control units 101 and 201 in the example as illustrated in FIG. 7. Here, processes performed after the data to be evicted from the L2 cache 103 in the L2 cache control unit 101 is determined are described. The controller 101a in the L2 cache control unit 101 requests the tag RAM 103a to invalidate the block in which the data is stored. Here, when the data is dirty and the controller 101a notifies a Write Back request to the controller 201a in the cluster 20 which is Home, the controller 101a reads data corresponding to the block from the data RAM 103b. And the controller 101a notifies a Flush Back request to the controller 201a. Alternatively, the controller 101a notifies a Write Back request to the controller 201a and sends the data to the controller 201a. When the controller 201a in the cluster 20 which is Home receives the request, the controller 201a invalidates the information in the directory RAM 204 indicating that “the data is held by the cluster 10 requesting the data”. In addition, when the controller 201a receives a Write Back request, the controller 201a writes back the data to the memory 202.

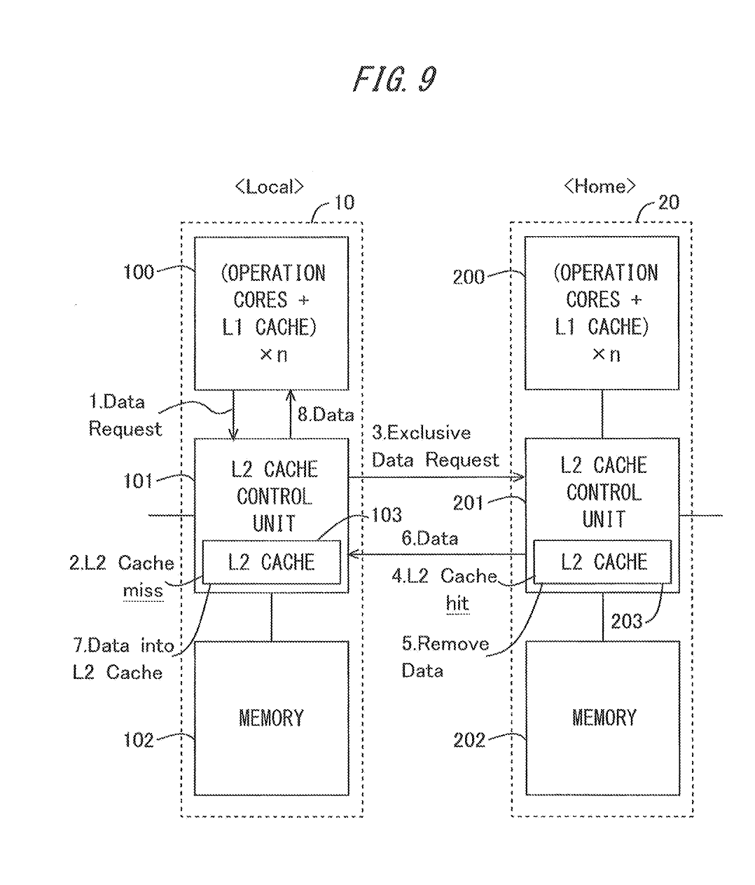

Next, FIG. 9 illustrates processes performed when the cluster 10 which is Local exclusively acquires data stored in the memory 202 in the cluster 20 which is Home. For example, when data is updated by a processor core, an exclusive data acquisition request is used. The exclusive data acquisition request is a request for ensuring that at a certain point of time one cluster (a cache in the cluster) holds the requested data and the other clusters do not hold the data. When the L2 cache in one of the other clusters holds the data when the data is updated, the data cannot be synchronized in the information processing apparatus 1. Thus, the exclusive data acquisition request is a request for preventing this situation.

First, a processor core in the group of processor cores 100 in the cluster 10 which is Local requests acquisition of data to the L2 cache control unit 101. When the L2 cache control unit 101 receives the data acquisition request, the L2 cache control unit 101 checks whether or not the data is stored in the L2 cache 103. When the data is not stored in the L2 cache 103 (miss), the L2 cache control unit 101 sends an exclusive data acquisition request for the data to the L2 cache control unit 201 in the cluster 20 which is Home. When the L2 cache control unit 201 receives the exclusive data acquisition request, the L2 cache control unit refers to the directory information stored in the L2 cache control unit 201. The directory information indicates which cluster including the Home cluster holds the data. And then the L2 cache control unit 201 sends a discard request of the data to the cluster holding the data indicated by the directory information.

In the example as illustrated in FIG. 9, the data is stored in the L2 cache 203. Therefore, the L2 cache control unit 201 discards the data from the L2 cache 203. The L2 cache control unit 201 sends the discarded data to the L2 cache control unit 101. In addition, the L2 cache control unit 201 stores in the directory information the information indicating that the cluster 10 requesting the data is a unique cluster holding the data. And then the cluster 10 requesting the data stores the data in the L2 cache 103.

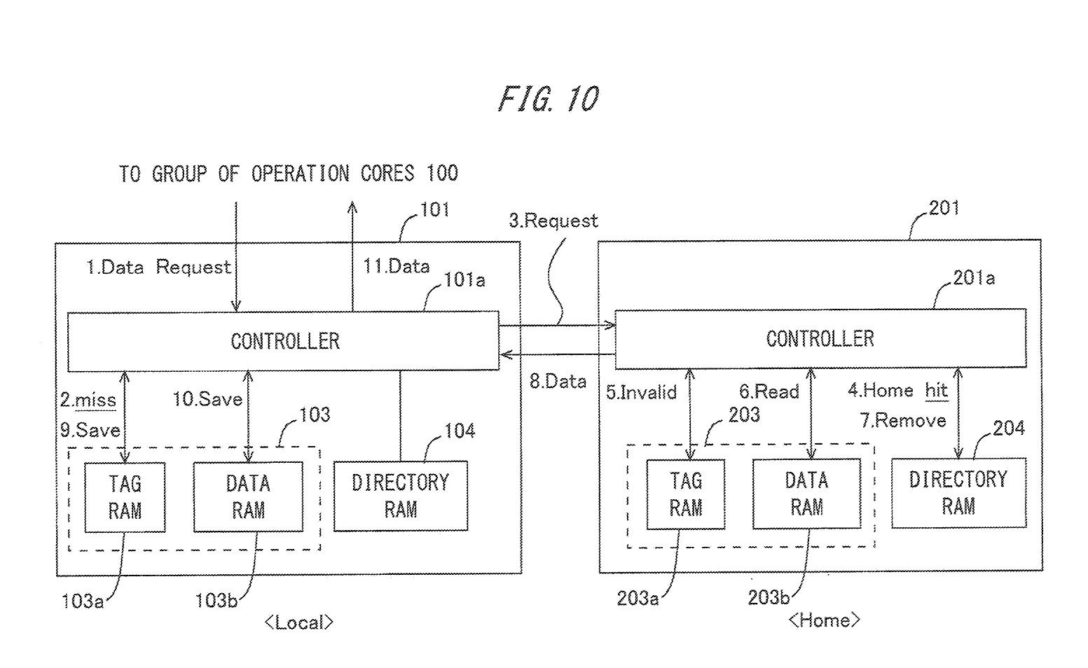

FIG. 10 is a diagram illustrating processes performed by the L2 cache control units 101 and 201 in the example as illustrated in FIG. 9. The controller 101a in the L2 cache control unit 101 in the cluster 10 which is Local accepts an exclusive data acquisition request from a processor core in the group of processor cores 100. The data acquisition request includes information indicating that the request is generated by the processor core, information indicating that the request is an exclusive data acquisition request and the address in the main memory storing the data. The controller 101a initiates appropriate processes according to the contents of the request.

The controller 101a checks the tag RAM 103a to determine whether or not a copy of the block in the main memory which stores the data as the target of the data acquisition request is found in the data RAM 103b. When the controller 101a receives a result indicating that the copy is not found (miss) from the tag RAM 103a, the controller 101a sends a data acquisition request of the data to the controller 201a in the L2 cache control unit 201 which belongs to the cluster 20 which is Home.

When the controller 201a receives the data acquisition request, the controller 201a checks the directory RAM 204 to determine whether or not the requested data is stored in an L2 cache in any cluster. When the controller 201a receives a result indicating that the data is held by the cluster 20 which is Home (hit), the controller 201a sends an invalidation request of the data to the tag RAM 203a. In addition, the controller 201a reads the data from the data RAM 203b. And then the controller 201a invalidates the information indicating that the data is held by a Home cluster in the directory RAM 204. Further, the controller 201a adds the information indicating that the cluster 10 requesting the data holds the data to the directory RAM 204. Moreover, the controller 201a sends the data to the controller 101a in the cluster 10 requesting the data. When the controller 101a in the cluster 10 receives the data, the controller 101a registers the status of use of the data in the tag RAM 103a. Additionally, the controller 101a stores the data in the data RAM 103b. And then the controller 101a sends the data to the processor core requesting the data in the group of processor cores.

As described above, when data stored in a main memory which belongs to a Remote cluster is requested, cache miss may occur in each L2 cache in Local, Home and Remote clusters in the comparative example. In this case, communications with memories are performed in addition to communications between clusters. The capacity of a main memory is larger than the capacity of a processor core. Therefore, latency associated with an access to a main memory is longer than the latency associated with an access to an L2 cache. In some cases, a main memory is located on a chip independent of a chip on which processor cores and L2 caches are located. Thus, the durations of communications between chips, namely off-chip communications, may be longer than the durations of communications in a chip, namely on-chip communications.

With the above descriptions of the comparative example in mind, an example of an information processing apparatus according to one embodiment is described below with reference to the drawings. In the descriptions below, the operation state and non-operation state of the group of operations cores in each cluster are controlled. In addition, an L2 cache in a cluster to which a group of processor cores in the non-operation state belongs is used as a cache for a group of processor cores in the operation state, namely as a Victim Cache. Therefore, when an application uses memory space beyond the capacity of a main memory in a cluster, accesses to the main memory are reduced to the extent possible. Further, latency associated with the accesses to the main memory is reduced. The details of these features are described below.

### Embodiment

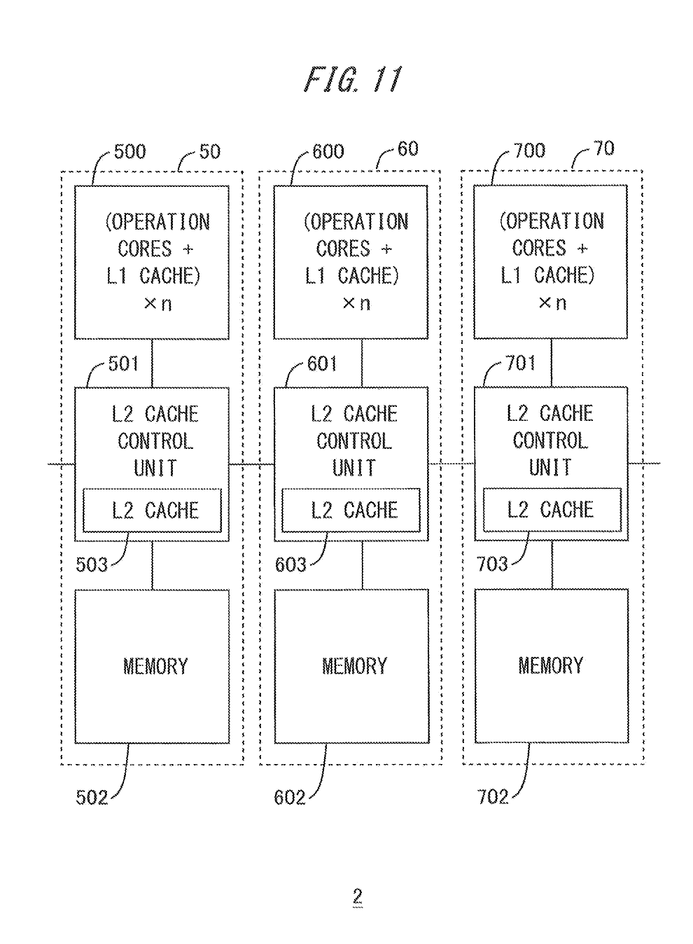

FIG. 11 schematically illustrates a part of a cluster configuration in an information processing apparatus 2 in the present embodiment. As illustrated in FIG. 11, similar to the comparative example, the information processing apparatus 2 includes clusters 50, 60 and 70. The clusters 50, 60 and 70 correspond to examples of operation processing apparatus. In addition, since the differences between Local, Home and Remote are similar to the comparative example as described above, the descriptions of Local, Home and Remote are omitted here. The cluster 50 includes a group of processor cores 500, an L2 cache control unit 501 and a memory 502. The L2 cache control unit 501 includes an L2 cache 503. The clusters 60 and 70 also include groups of processor cores 600 and 700, L2 cache control units 601 and 701, memories 602 and 702 and L2 caches 603 and 703 respectively. The groups of processor cores 500, 600 and 700 correspond to examples of operation processing units. In addition, the L2 caches 503, 603 and 703 correspond to examples of cache memories. Further, the L2 cache control units 501, 601 and 701 correspond to examples of control units. Moreover, the clusters 50, 60 and 70 form one group. The group denotes an assembly of clusters which handle processes performed in one application. However, the criteria for forming a group are not limited to this denotation and the clusters may be arbitrarily divided into groups.

As illustrated in FIG. 11, an L2 cache controller in each cluster is connected with each other via a bus or an interconnect. In the information processing apparatus 2, the memory space is so-called flat so that it is uniquely determined according to physical addresses which data is stored and in which cluster the data is stored in a main memory.

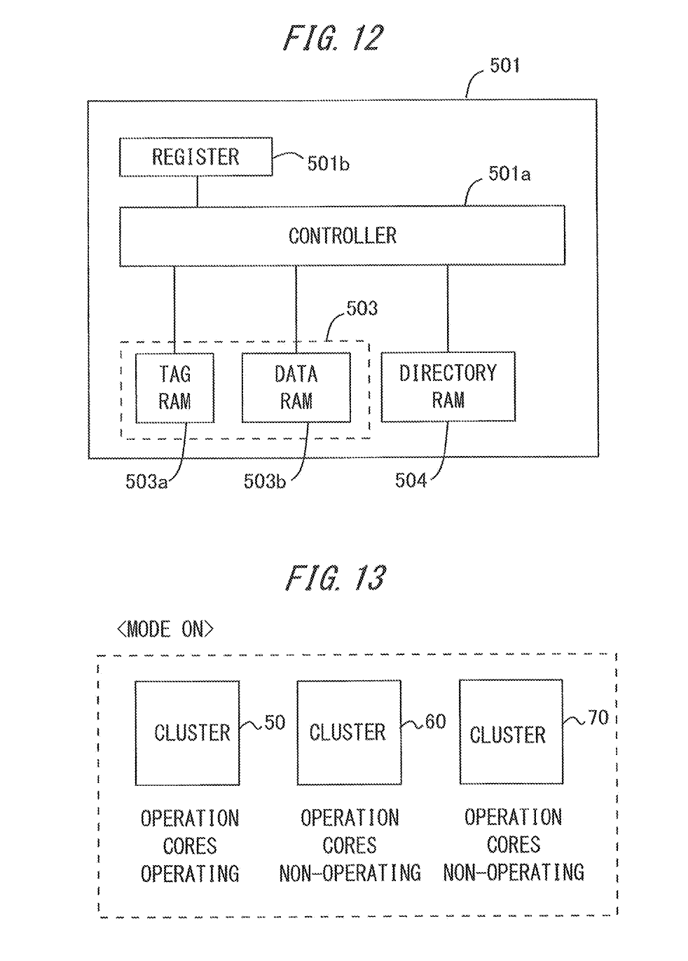

FIG. 12 is a diagram illustrating the L2 cache control unit 501 in the cluster 50. The L2 cache control unit 501 includes a controller 501a, a register 501b, the L2 cache 503 and a directory RAM 504. In addition, the L2 cache 503 includes a tag RAM 503a and a data RAM 503b. Further, the register 501b corresponds to an example of a setting unit. Since the functions of the tag RAM 503a, the data RAM 503b and the directory RAM 504 are similar to the comparative example, the detailed descriptions are omitted here.

The register 501b controls the operation mode of the cluster 50 in the information processing apparatus 2 according to the present embodiment. In the present embodiment, the operation mode includes three modes which are “mode off”, “mode on and processor cores operating” and “mode on and processor cores non-operating”. The operation mode “mode off” is an operation mode in which a cluster operates as described in the above comparative example. The operation mode “mode on and processor cores operating” is an operation mode in which a cluster sets the group of processor cores to an operating state and performs processes in the present embodiment (mode on). The operation mode “mode on and processor cores non-operating” is an operation mode in which a cluster sets the group of processor cores to a non-operating state and performs processes in the present embodiment. The details of the processes in these operation modes are described later.

The controller 501a reads setting values for the register 501b and switches the operation modes according to the setting values. In addition, the operation modes are switched before application execution in the information processing apparatus in the present embodiment. In addition, the OS (Operating System) of the information processing apparatus 2 controls the switching of the operation modes of the register in each cluster. It is noted that the switching of the operation modes can be performed by a user of the information processing apparatus 2 to explicitly instruct the OS or by the OS to autonomously instruct according to the information such as the memory usage of the application.

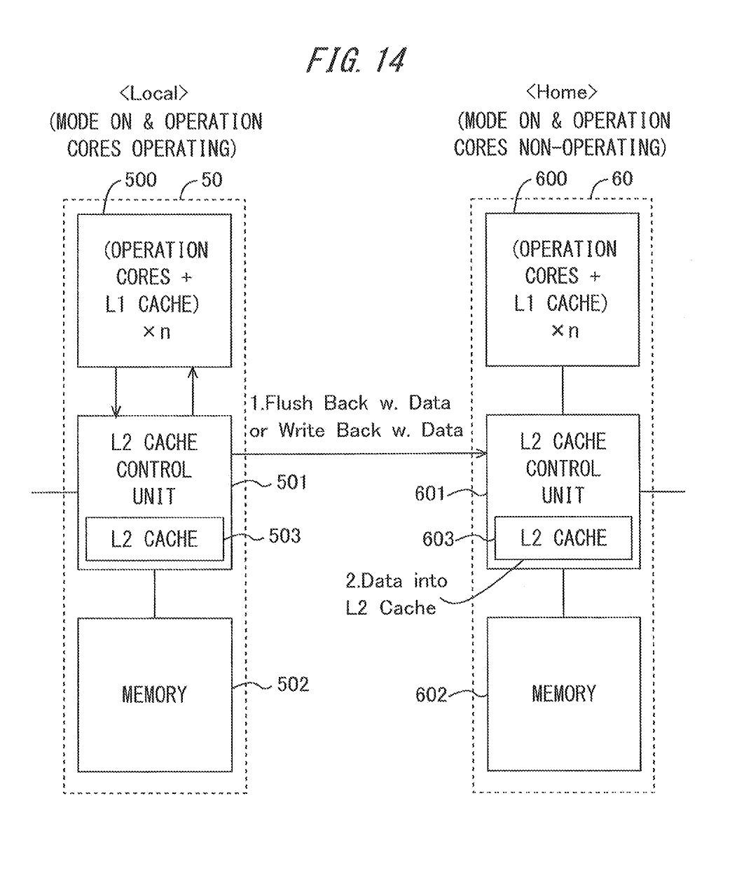

FIG. 13 is a diagram illustrating operation states of the groups of processor cores in the clusters 50, 60 and 70 when the operation mode is “mode on” in the information processing apparatus 2. As an example, the clusters 50, 60 and 70 in a group are controlled so that the group of processor cores in one of the clusters 50, 60 and 70 operates. In FIG. 13, the operation mode of the cluster 50 is “mode on and processor cores operating” and the operation modes of the clusters 60 and 70 are “mode on and processor cores non-operating”. Thus, the group of processor cores 500 in the cluster 50 is in the operating state and the groups of processor cores 600 and 700 are in the non-operating state. As an example, groups of clusters such as the clusters 50, 60 and 70 are formed in the information processing apparatus 2. And each group corresponds to one series of processes performed in the information processing apparatus 2.

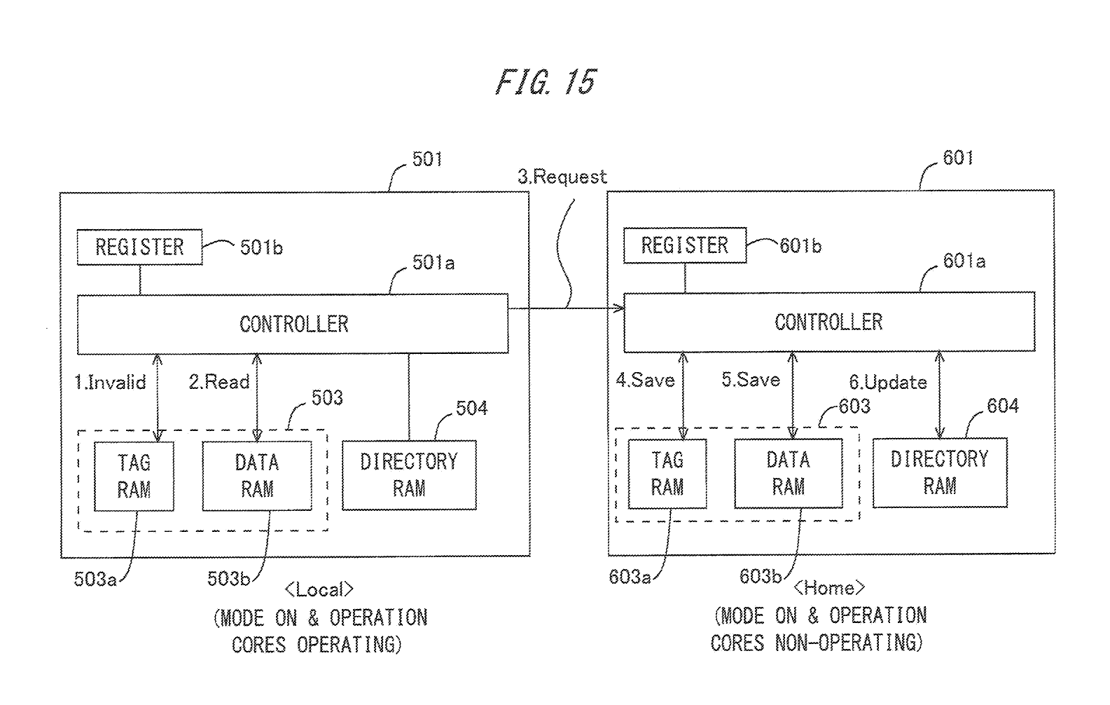

FIG. 14 is a diagram illustrating processes performed when data to be stored in the memory 602 in the cluster 60 is evicted from the L2 cache 503 which belongs to the cluster 50 according to the present embodiment. Similar to the comparative example, when the L2 cache control unit 501 stores new data in the L2 cache 503 and the L2 cache 503 does not have capacity for the data, the L2 cache control unit 501 evicts data from the L2 503 cache according to a predetermined algorithm. The L2 cache control unit 501 refers to the tag RAM 503a to determine that the data to be evicted is clean or dirty. When it is determined that the data to be evicted is clean, the L2 cache control unit 501 notifies a Flush Back request to the L2 cache control unit 601 and sends the data to the L2 cache control unit 601. On the other hand, when it is determined that the data to be evicted is dirty, the L2 cache control unit 501 notifies a Write Back request to the L2 cache control unit 601 and sends the data to the L2 cache control unit 601.

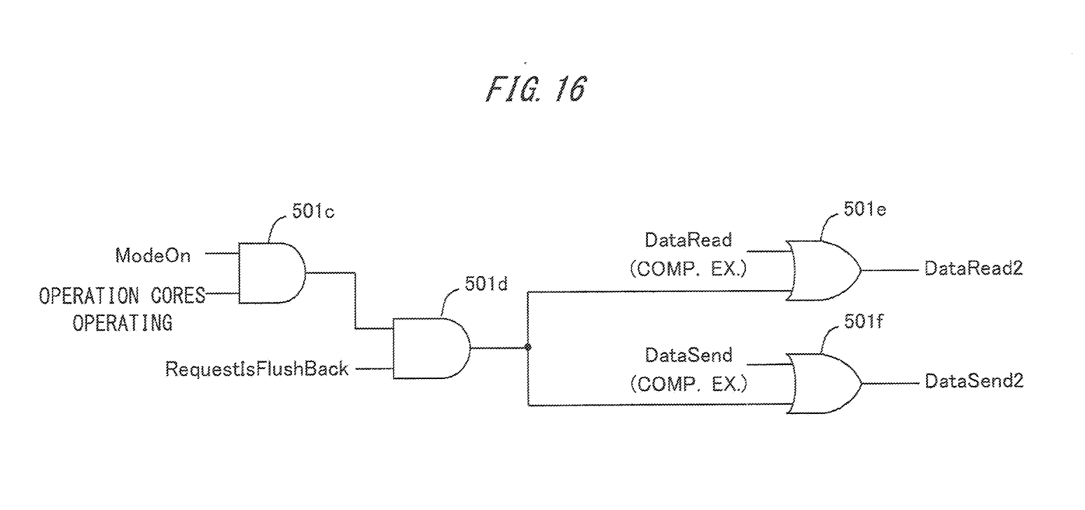

FIG. 15 is a diagram illustrating processes performed in the L2 cache control units 501 and 601 in the example as illustrated in FIG. 14. As described above, the L2 cache control units 501 and 601 include the controllers 501a and 601a, the registers 501b and 601b, the L2 caches 503 and 603 and the directory RAMs 504 and 604 respectively. In addition, the L2 caches 503 and 603 include the tag RAMs 503a and 603a and the data RAMs 503b and 603b respectively.

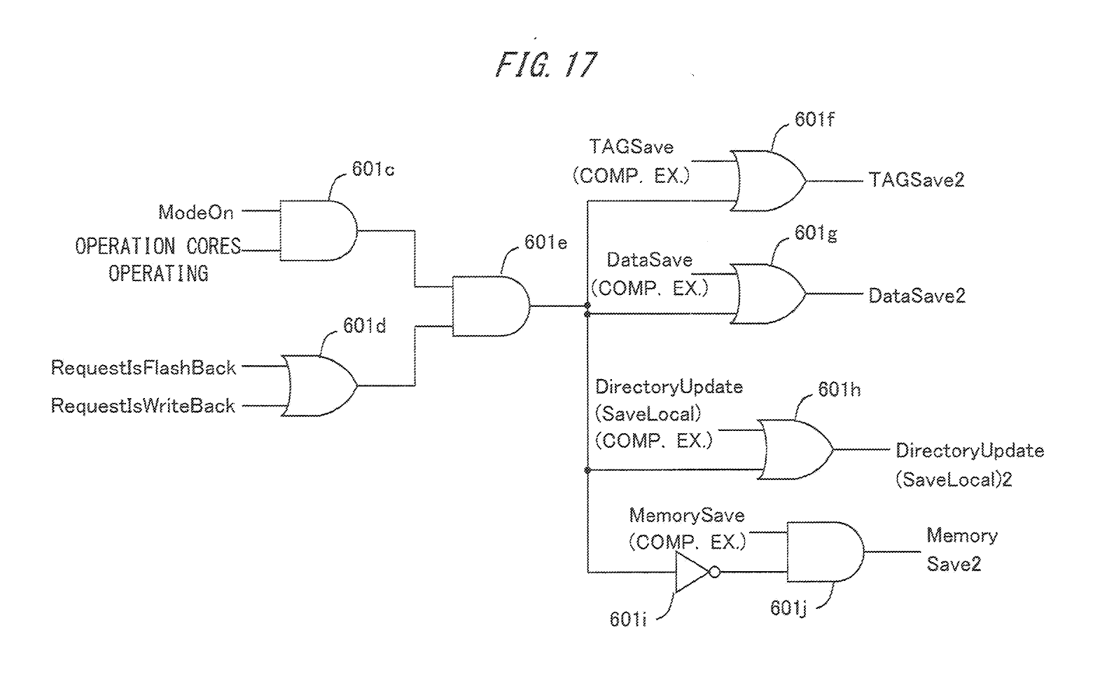

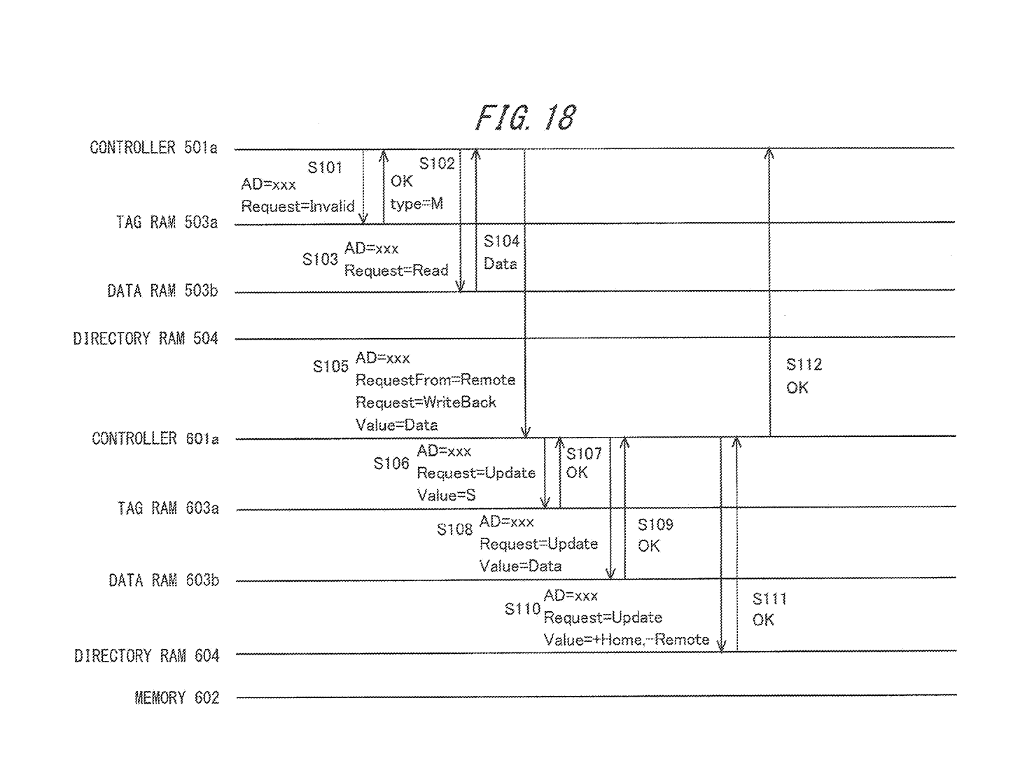

Additionally, FIGS. 16 and 17 respectively illustrate parts of circuits in the controllers 501a and 601a in the example as illustrated in FIG. 14. The circuit in the controller 501a as illustrated in FIG. 16 is a control circuit used when the cluster 50 is Local and the operation mode is “mode on and processor cores operating”. When data to be stored in the memory 602 in the cluster 60 which is Remote is evicted from the L2 cache 503 in the cluster 50 which is Local, the data is sent to the cluster 60 which is also Home by the circuit in the controller 501a as illustrated in FIG. 16. That is, when the controller 501a refers to the tag RAM 503a to determine that the data is clean, RequestIsFlushBack is asserted in the control circuit as illustrated in FIG. 16. When RequestIsFlushBack is asserted, the evicted data is sent to the cluster 60. It is noted in FIG. 16 that DataRead, which denotes reading data from a data RAM, and DataSend, which denotes sending data to a Home cluster, are signals for instructing an operation and the other signals are flag signals.

As illustrated in FIG. 16, an AND gate 501c outputs “1” when the operation mode of the cluster 50 is “mode on and processor cores operating”. The AND gate 501c outputs “0” in other cases. In addition, an AND gate 501d outputs “1” when the AND gate 501c outputs “1” and a Flush Back process is performed. The AND gate 501d outputs “0” in other cases.

An OR gate 501e outputs an instruction signal DataRead2 for reading data in the data RAM 503b when the AND gate 501d outputs “1” or the data RAM 503b is referred according to the processes in the comparative example. An OR gate 501f outputs an instruction signal DataSend2 for sending data to a Home cluster when the AND gate 501d outputs “1” or data is sent to a Home cluster according to the processes in the comparative example. Since circuits subsequent to the OR gates 501e and 501f are conventional circuits, the detailed descriptions and drawings of the subsequent circuits are omitted here.

When the operation mode of the cluster 50 is “mode on and processor cores operating” and a Flush Back request is generated in the cluster 50 which is Local, reading data from the data RAM 503b in the L2 cache 503 (DataRead2) is instructed according to the outputs from the AND gates 501c and 501d. In addition, an instruction signal (DataSend2) is output for transferring the read data to a Home cluster. On the other hand, when the operation mode is “mode off” or “processor core non-operating”, the And gate 501c outputs “0”. And the AND gate 501d blocks the Flush Back request signal (RequestIsFlushBack) generated in the cluster 50 which is Local. In a case in which the Flush Back request signal is blocked, when data is read from the tag RAM 503a or the data RAM 503b as described in the comparative example or when data is transferred to another cluster, the OR gates 501e and 501f output instruction signals to perform appropriate control processes (“DataRead in comparative example” and “DataSend in comparative example” in FIG. 16).

FIG. 17 illustrates a control circuit in the controller 601a used when the cluster 60 is Home and the operation mode is “mode on and processor cores non-operating”. The circuit in the controller 601a as illustrated in FIG. 17 stores data evicted from the cluster 50 which is Local in the L2 cache 603. In FIG. 17, TAGSave for storing data in a tag RAM, DataSave for storing data in a data RAM, DirectoryUpdate (SaveLocal) for updating directory information in a directory RAM and MemorySave for storing data in a main memory are signals for instructing an operation. And the other signals are flag signals in FIG. 17.

An AND gate 601c outputs “1” when the operation mode of the cluster 60 is “mode on and processor cores non-operating”. In other cases, an AND gate 601c outputs “0”. An OR gate 601d outputs “1” when the cluster 60 receives a Flush Back request or a Write Back request from the cluster 50 which is Local.

When an AND gate 601e outputs “1” or data related to the status of use of data is registered in the tag RAM 603a according to the processes in the comparative example, an OR gate 601f outputs an instruction signal (TagSave2) for registering the data in the tag RAM 603a. In addition, when the AND gate 601e outputs “1” or data is evicted to the data RAM 603b according to the processes in the comparative example, an OR gate 601g outputs an instruction signal (DataSave2) for storing data in the data RAM 603b. Further, when the AND gate 601e outputs “1” or the directory information in the directory RAM 604 is updated, an OR gate 601h outputs an instruction signal (DirectoryUpdate(SaveLocal)2) for updating the directory information in the directory RAM 604.

An AND gate 601j inhibits storing data in the memory 602 when the operation mode of the cluster 60 is “mode on and processor cores non-operating” and a Flush Back request signal sent from the cluster 50 is asserted. Alternatively, the AND gate 601j inhibits storing data in the memory 602 when the operation mode of the cluster 60 is “mode on and processor cores non-operating” and a Write Back request signal sent from the cluster 50 is asserted. On the other hand, the AND gate 601j outputs an instruction signal (MemorySave2) for storing data in the memory 602 when the operation mode of the cluster 60 is “mode off” or “processor cores operating” and data is stored in the memory 602 according to the processes in the comparative example. Alternatively, the AND gate 601j outputs the instruction signal (MemorySave2) when the cluster 50 notifies nether a Flush Back request nor a Write Back request and data is stored in the memory 602 according to the processes in the comparative example. It is noted that since circuits subsequent to the OR gates 601f to 601h and the AND gate 601j are conventional circuits, the detailed descriptions and drawings of the subsequent circuits are omitted here.

Consequently, when the group of processor cores 600 in the cluster 60 is in the operating state, the AND gate 601e outputs “0”. Thus, TAGSave2, DataSave2, DirectoryUpdate(SaveLocal)2 and MemorySave 2 are not asserted when a Flush Back request (RequestIsFlushBack) is received from the cluster 50 which is Local. Alternatively, processes according to the processes in the comparative example are performed based on TAGSave, DataSave, DirectoryUpdate(SaveLocal) and MemorySave.

To the contrary, the AND gate 601e outputs “1” when the operation mode of the cluster 60 is “mode on and processor cores non-operating” and the controller 601a receives a Flush Back request or a Write Back request. In this case, the OR gate 601f outputs “1” and the tag RAM 603a is requested to update the information related to evicted data. In addition, the OR gate 601g outputs “1” and the evicted data is stored in the data RAM 603b in the L2 cache 603. Further, the OR gate 601h outputs “1” and the directory RAM 604 is requested to update the information related to the evicted data. And then the inverter 601i outputs “0”, the AND gate 601j outputs “0” and the data is not stored in the memory 602. As a result, neither an access to the memory 602 nor additional latency is required.

Here, as illustrated in FIG. 15, the controller 501a requests the tag RAM 503a to register that the data is evicted from the data RAM 503b (Invalid). Next, the controller 501a retrieves from the data RAM 503b the data to be evicted. The controller 501a notifies a Flush Back request to the controller 601a in the cluster 60 which is Home and sends the evicted data to the controller 601a when the retrieved data is synchronized in the information processing apparatus 2, that is, the retrieved data is clean. In addition, the controller 501a notifies a Write Back request to the controller 601a and sends the retrieved data to the controller 601a when the retrieved data is not synchronized in the information processing apparatus 2.

The controller 601a in the cluster 60 which is Home receives the above Flush Back request or the above Write Back request from the controller 501a in the cluster 50 which is Local. And, the controller 601a stores the data which is received along with one of the above requests, that is, the data evicted from the data RAM 503b in the data RAM 603b. Therefore, the controller 601a updates the information stored in the tag RAM 603a to indicate that the data is stored in the data RAM 603b. And then the controller 601a requests the directory RAM 604 to update the directory information to indicate that the data is added to the cluster 60 which is Home. Further, the controller 601a requests the directory RAM 604 to indicate that the data is discarded from the cluster 50 which is Local.

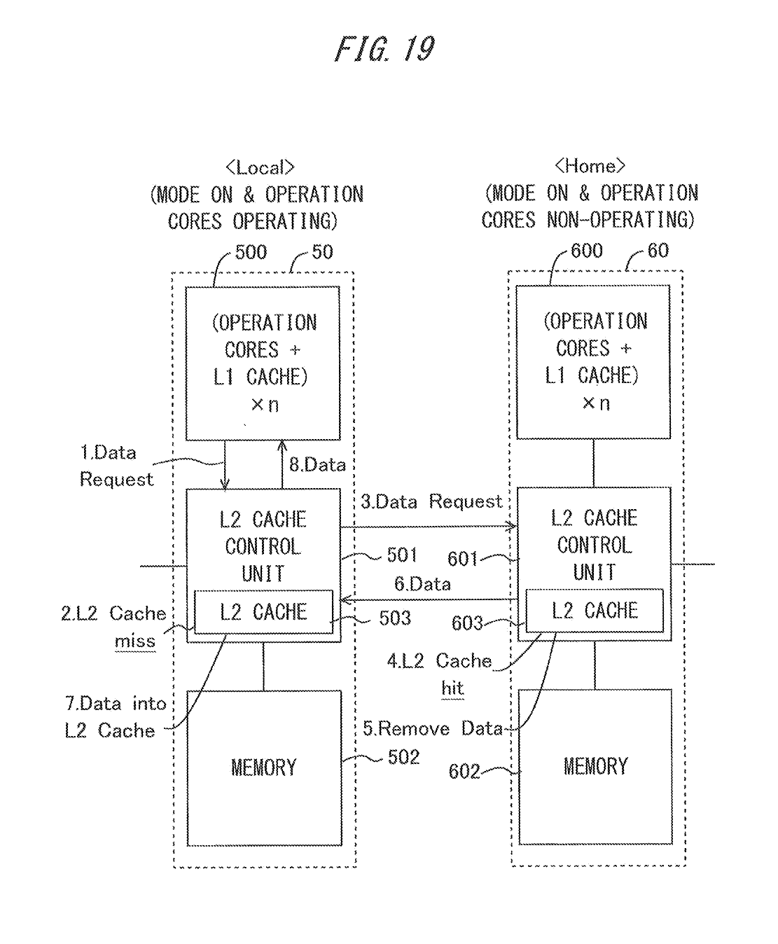

FIG. 18 is a timing chart for the L2 cache control units 501 and 601 in the example as illustrated in FIGS. 15 to 17. In the following descriptions, a step in the timing chart is abbreviated to S. FIG. 18 illustrates a case in which the controller 501a sends a Write Back request to the controller 601a. In S101, the controller 501a requests the tag RAM 503a to register the information which indicates that the data is evicted from the data RAM 503b (Invalid). It is noted that an algorithm is used to determine in advance which data is evicted. In S102, the tag RAM 503a sends to the controller 501a the information which indicates the status of use of the data (Modified; Value=M) in the response to the request. In S103, the controller 501a uses the address acquired from the tag RAM 503a to read the data from the data RAM 503b. In S104, the data RAM 503b reads the data of which the address matches with the address included in the request from the controller 501a and sends the data to controller 501a.

When the controller 501a receives the data evicted from the data RAM 503b, the controller 501a sends in S105 a Flush Back request or a Write Back request with the data to the controller 601a. The controller 501a sends the Flush Back request or the Write Back request according to the status of use of the data (clean or dirty) retrieved from the tag RAM 503a in S102. In FIG. 18, the controller 501a sends a Write Back request to the controller 601a. In addition, the controller 501a sends to the controller 601a the address which indicates in which cluster the data is stored in a main memory.

In S106, the controller 601a requests the tag RAM 603a to register the information which indicates that the data sent from the controller 501a is stored in the data RAM 603b. In addition, the controller 601a requests the tag RAM 603a to register the address which indicates in which cluster the data is stored in a main memory. In S107, the tag RAM 603a performs the registration process according to the request from the controller 601a and notifies the controller 601a that the process is completed. In S108, the controller 601a stores the data in the data RAM 603b. In S109, the data RAM 603b stores the data and notifies the controller 601a that the storing process is completed.

In S110, the controller 601a requests the directory RAM 604 to update the directory information to indicate that the data is held by the cluster 60 which is Home. Further, the controller 601a requests the directory RAM 604 to update the directory information to indicate that the data is discarded from the cluster 50 which is Local as well as Remote. In S111, the directory RAM 604 updates the directory information and notifies the controller 601a that the updating process is completed. In S112, the controller 601a notifies the controller 501a that the above processes are completed.

It is noted that in a cluster a directory RAM uses the directory information to administer which cluster retrieves each data stored in a data RAM by use of a bit corresponding to each cluster. For example, for each data a bit “1” is used for a cluster which holds the data and a bit “0” is used for a cluster which does not hold the data. Therefore, for example, in S110 as described above, the directory RAM 604 sets the bit for the cluster 60 to “1” and sets the bit for the cluster 50 to “0”. In the following descriptions, a directory RAM changes the bits in the directory information to register the status of use of each data. However, the configuration for administering the status of data retrieved by clusters in the directory RAM is not limited to the above embodiment.

Since the processes performed by the controller 601a are the same as above when the controller 501a sends a Flush Back request to the controller 601a, the detailed descriptions of the processes are omitted here. In addition, the above example employs the configuration in which the controller 501a sends a Flush Back request or a Write Back request to the controller 601a. However, a configuration in which the controller 501a sends a Write Back instead of the Flush Back request can be employed. In this case, the cluster 60 which is Home does not distinguish between a case of sending a Flush Back request and a case of sending a Write Back request. In addition, a configuration can be employed so that the group of processor cores 600 is set to the non-operating state according to the settings of the register 601b and data received from the cluster 50 which is Remote is stored in the L2 cache 603. Thus, efforts can be saved for changing the configurations of the cluster 60 which is Home.

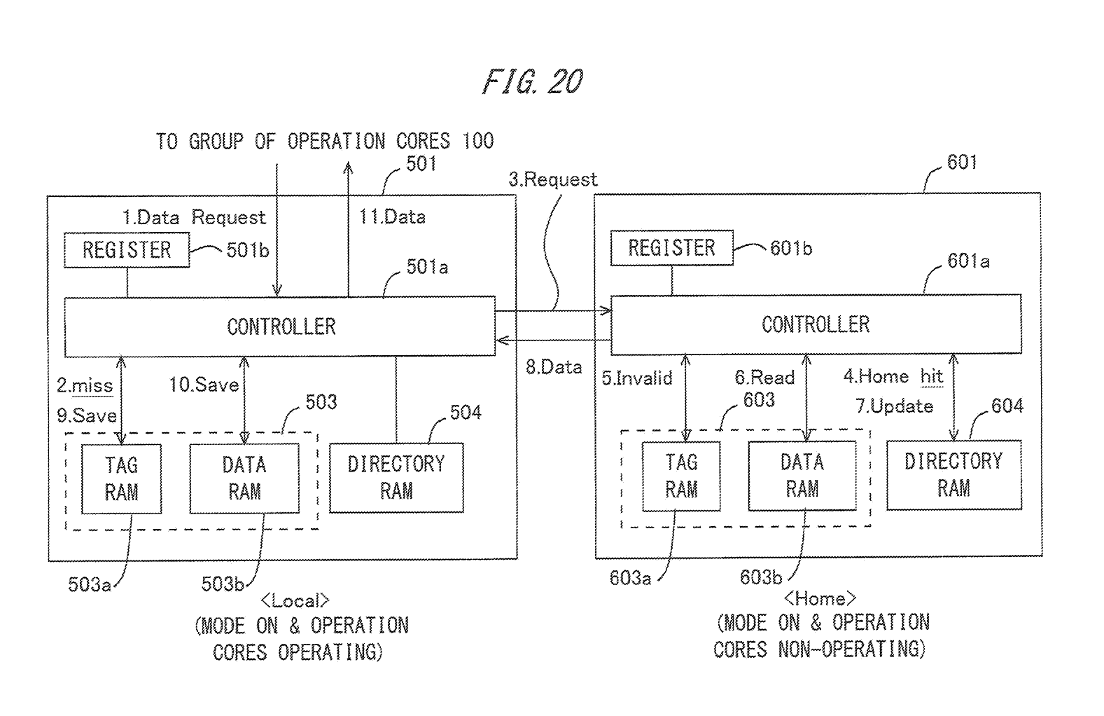

FIG. 19 is a diagram illustrating processes performed when the cluster 50 which is Local requests data stored in the memory 602 in the cluster 60 which is Home. Similar to the comparative example, when data requested from the group of processor cores 500 is not found in the L2 cache 503 (cache miss) the L2 cache control unit 501 requests the L2 cache control unit 601 in the cluster 60 to send the data. In the present embodiment, the descriptions are provided for a case in which the data is stored in the L2 cache 603. The L2 cache control unit 601 evicts the data from the L2 cache 603 and the sends the evicted data to the L2 cache control unit 501. It is noted that when the data is not stored in the L2 cache 603 the L2 cache control unit 601 acquires the data from the memory 602 and sends the data to the L2 cache control unit 501.

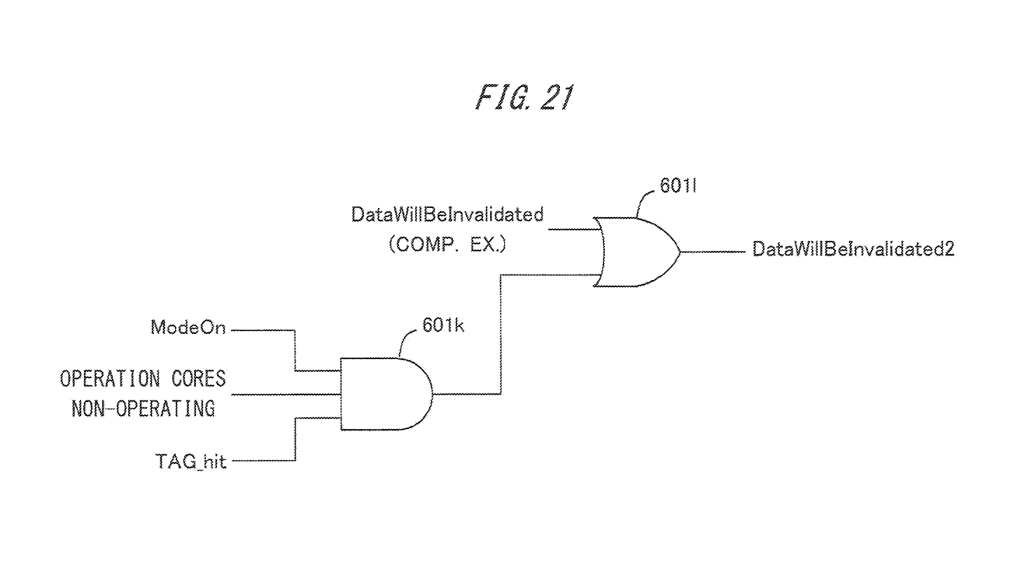

FIG. 20 is a diagram illustrating processes performed by the L2 cache control units 501 and 601 in the example as illustrated in FIG. 19. As described above, the L2 cache control units 501 and 601 include the controllers 501a and 601a, the registers 501b and 601b, the L2 cache 503 and 603 and the directory RAMs 504 and 604 respectively. In addition, the L2 caches 503 and 603 include the tag RAM 503a and 603a and the data RAM 503b and 603b.

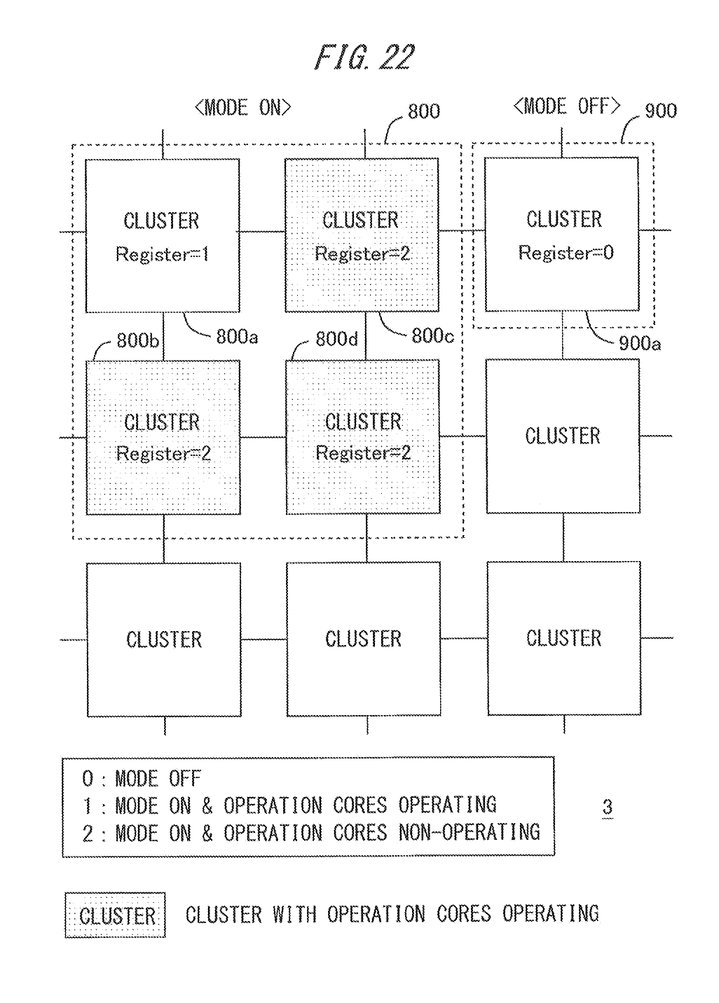

FIG. 21 is a diagram illustrating a circuit included in the controller 601a. The circuit included in the controller 601a as illustrated in FIG. 21 is a control circuit used when the operation mode of the cluster 60 is “mode on and processor cores non-operating”. Further, the controller 601a as illustrated in FIG. 21 is a control circuit which operates not only when the controller 501a performs an exclusive data acquisition request but also when a data acquisition request such as a request for acquiring data which can be shared with other clusters is performed. Moreover, when data requested from the controller 501a is found in the L2 cache 603 (cache hit) the controller 601a as illustrated in FIG. 21 sends the data to the controller 501a. Additionally, the controller 601a discards the data from the L2 cache 603. In FIG. 21, DataWillBeInvalidated, which is used for discarding target data in the data RAM, is a signal for instructing an operation. And the other signals are flag signals in FIG. 21.

As illustrated in FIG. 21, an AND gate 601k outputs “1” when the operation mode of the cluster 60 is “mode on and processor cores non-operating” and requested data is found in the data RAM 603b (cache hit). In other cases the And gate 601k outputs “0”. When the AND gate 601k outputs “1” or acquired data is discarded from the data RAM according to the processes in the comparative example, an OR gate 601l outputs an instruction signal (DataWillBeInvalidated2) for discarding the acquired data from the data RAM 603b. Since circuits subsequent to the OR gate 601l are conventional circuits, the detailed descriptions and drawings of the subsequent circuits are omitted here.

It is assumed here that the controller 501a notifies a data acquisition request to the controller 601a in the control circuit as illustrated in FIG. 21. When the requested data is stored in the data RAM 603b, the controller 601a acquires the data from the data RAM 603b. And the controller 601a sends the acquired data to the controller 501a. In addition, the controller 601a discards the data from the data RAM 603b.

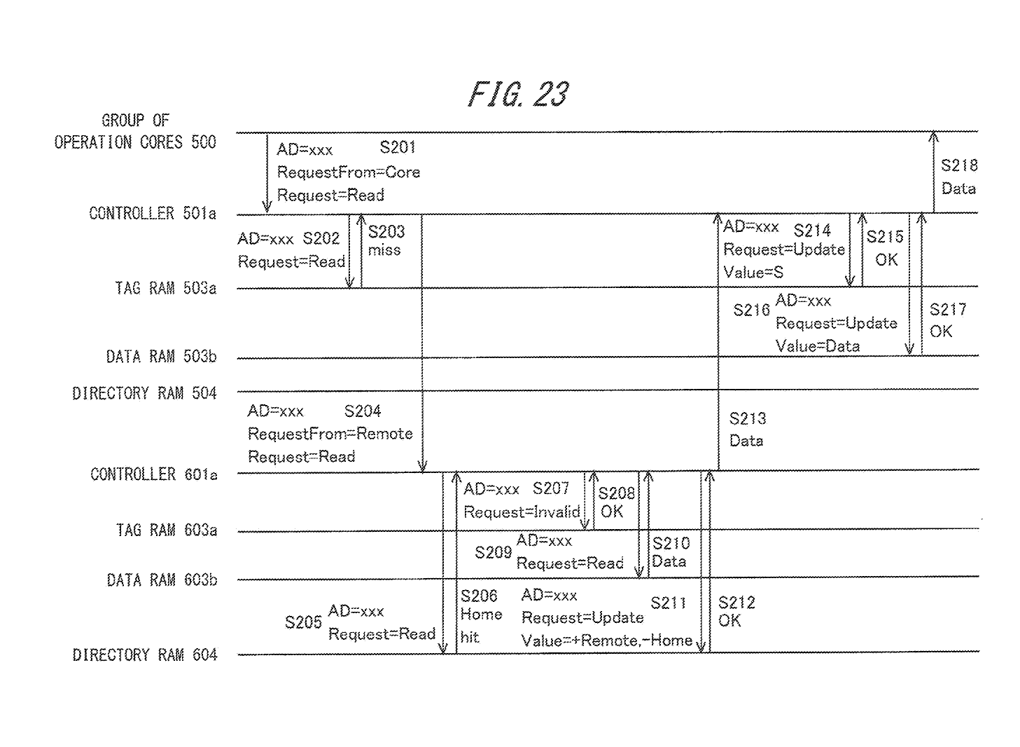

An example of the advantages obtained when the controller 601a operates according to the control circuit as illustrated in FIG. 21 is described with reference to FIG. 22. FIG. 22 illustrates an example in which a plurality of groups of clusters are configured in an information processing apparatus 3. It is noted that the operation mode of each cluster is set according to a setting value of a register in an L2 cache control unit in each cluster. Specifically, the operation mode is set to “mode off” when the setting value is 0, set to “mode on and processor cores operating” when the setting value is 1 and set to “mode on and processor cores non-operating” when the setting value is 2. In FIG. 22, clusters 800a to 800d form a group 800. In addition, a cluster 900a forms a group 900. The group 900 is used for executing an application for which the required memory space is equal to or smaller than the capacity of a main memory in the group 900. Since the configurations of the clusters 800a to 800d and 900a are similar to the configurations of the clusters 50 and 60 as described above, the detailed descriptions and drawings of the components of the clusters are omitted here. Further, since the clusters 800a to 800d and 900a employ the circuit as illustrated in FIG. 21, the symbols and the descriptions as provided above are used in a similar manner below.

In FIG. 22, the operation modes of the clusters 800b to 800d are “mode on and processor cores non-operating”. In addition, the operation mode of the cluster 900a is “mode off”. Therefore, a part of groups in the information processing apparatus 3 can be controlled to perform the processes according to the present embodiment and the other groups can be controlled to perform the processes according to the comparative example. Two example cases are described below. One is a case in which the cluster 800a acquires data from the L2 cache in the cluster 800b and the other is a case in which the cluster 800a acquires data from the L2 cache in the cluster 900a.

First, it is assumed that the cluster 800a acquires data from the cluster 800b. In this case, the cluster 800a is Local and the cluster 800b is Home. And the cluster 800a notifies a data acquisition request to the cluster 800b. When the cluster 800b receives the data acquisition request from the cluster 800a, the AND gate 601k in the circuit as illustrated in FIG. 21 in the controller in the cluster 800b outputs “1”. In addition, the OR gate 601l outputs “1”. Therefore, the cluster 800b acquires the data from the L2 cache, sends the data to the cluster 800a and discards the data from the L2 cache.

Next, it is assumed that the cluster 800a acquires data from the L2 cache in the cluster 900a. In this case, the cluster 800a is Local and the cluster 900a is Home. And the cluster 800a notifies a data acquisition request to the cluster 900a. It is noted that the operation mode of the cluster 900a is “mode off”. Therefore, when the cluster 900a receives the above instruction, the AND gate 601k in the circuit as illustrated in FIG. 21 in the controller in the cluster 900a outputs “0”. Thus, the OR gate 601l does not output an instruction signal for discarding the acquired data from the L2 cache. And the cluster 900a acquires the data from L2 cache and sends the data to the cluster 800a. In addition, the data is still stored in the L2 cache in the cluster 900a.

Namely, in a case in which data acquisition is performed between clusters in a group in the example as illustrated in FIG. 22, when the data is acquired from an L2 cache the data is discarded from the L2 cache. Thus, the capacity of the L2 cache can be effectively used in the information processing apparatus 3. In addition, the synchronization of the data can be achieved in the information processing apparatus 3. Further, when a cluster outside of the group acquires the data, the processor cores in the cluster are operating. Thus, the data may be used by the processor cores in the cluster. Therefore, in this case, the information processing apparatus can be configured that the data is not discarded from the L2 cache when the data is acquired from the L2 cache in the cluster outside of the group.

Moreover, it is assumed that for example the cluster 900a outside of the group 800 requests data stored in the main memory in the cluster in the group 800 in the example as illustrated in FIG. 22. In this case, the cluster 900a sends a data acquisition request to the cluster 800a of which the operation mode is “mode on and processor cores operating”. That is, the cluster 900a does not access to the clusters 800b to 800d, of which the operation modes are “mode on and processor cores non-operating”. It is noted that the processes performed when a cluster outside of a group requests data stored in a main memory in a cluster inside of the group are controlled by the coordination performed by software such as Operating System. That is, the clusters outside of the group are controlled to access to the cluster of which the operation mode is “mode on and processor cores operating” in the group. As a result, the clusters outside of the group can acquires the operation results of the cluster of which the operation mode is “mode on and processor cores operating” in the group more smoothly and more quickly than the clusters in the comparative example.

Additionally, it is assumed that the cluster 900a is allowed to access to the cluster 800c for example. In addition, it is assumed that the cluster 900a sends an exclusive data acquisition request to acquire data stored in the L2 cache in the cluster 800c. In this case, the data is sent to the cluster 900a and discarded from the L2 cache in the cluster 800c. Further, the cluster 800c uses the directory information to administer the status of use of the data to indicate that the data is acquired by the cluster 900a outside of the group. Therefore, in the example as illustrated in FIG. 22, the accesses from the clusters outside of the group are limited to the cluster of which the operation mode is “mode on and processor cores operating” in the group. As a result, the data stored in the L2 cache in the clusters of which the operation modes are “mode on and processor cores non-operating” is not acquired by the clusters outside of the group. Thus, there is not a concern that when the cluster of which the operation mode is “mode on and processor cores operating” acquires data in the cluster of which the operation mode is “mode on and processor cores non-operating”, the dada is required to be retrieved from the cluster outside of the group because the data is held by the cluster outside of the group. Consequently, each cluster in the group can effectively acquire data from each other.

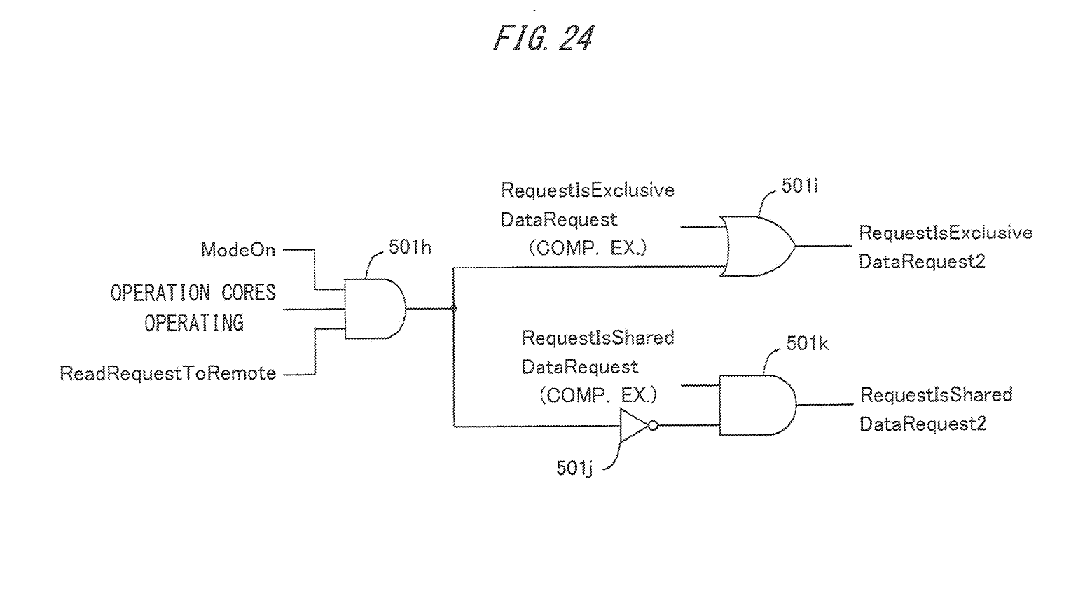

Next, FIG. 23 is a timing chart for the L2 cache control units 501 and 601 in the example as illustrated in FIGS. 19 to 21. First, in S201, the controller 501a in the L2 cache control unit 501 receives a data acquisition request from a processor core in the group of processor cores 500. The data acquisition request includes information of the address indicating in which cluster the data is stored in a main memory. In S202, the controller 501a checks the tag RAM 503a to determine whether or not the data corresponding to the address is stored in the data RAM 503b. In the present embodiment, in 5203, the tag RAM 503a returns information indicating that the data is not found in the data RAM 503b (cache miss) to the controller 501a.

In S204, the controller 501a uses the address of the data requested by the data acquisition request from the group of processor cores 500 to determine that the data is stored in the memory 602. Therefore, the controller 501a sends a data acquisition request for the data to the controller 601a.

In S205, the controller 601a checks the directory information in the directory RAM 604 to determine the status of use of the data in the group to which the cluster 60 belongs. The status of use of the data includes information indicating whether or not the data is held by other clusters. In the present embodiment, in S206, the directory RAM 604 detects the directory information indicating that the data is stored in the data RAM 603b. And then the directory RAM 604 sends the information indicating that the data is stored in the data RAM 603b to the controller 601a.

When the controller 601a receives the data acquisition request from the controller 501a, the controller 601a outputs an instruction signal for discarding the requested data from the data RAM 603b according to the control circuit as illustrated in FIG. 21. Therefore, in S207, the controller 601a requests the tag RAM 603a to invalidate the data stored in the data RAM 603b. When the data is invalidated, the data is not acquired by other clusters while the data is held by the cluster 50. As a result, the capacity of the L2 cache in the cluster can be effectively used in the information processing apparatus 2. In addition, the data can be synchronized in the information processing apparatus 2 more easily than the comparative example. In S208, the tag RAM 603a registers information indicating that the data is invalidated. And the tag RAM 603a notifies the controller 601a that the registration process is completed. In S209, the controller 601a requests the data RAM 603b to read the data. In S210, the data RAM 603b reads the requested data and sends the data to the controller 601a.

In S211, the controller 601a requests the directory RAM 604 to update the directory information to indicate that the data is held by the cluster 50 which is also Remote and that the data is discarded from the cluster 60 which is Home. In S212, the directory RAM 604 updates the directory information according to the request and notifies the controller 601a that the updating process is completed. In S213, the controller 601a sends the data to the controller 501a.

In S214, the controller 501a requests the tag RAM 503a to update the information to indicate that the data is stored in the data RAM 503b. In addition, the controller 501a also requests the tag RAM 503a to register the status of use of the data as “Shared”. In S215, the tag RAM 503a notifies the controller 501a that the updating process and the registration process are completed. In S216, the controller 501a requests the data RAM 503b to store the data. In S217, when the data RAM 503b stores the data, the data RAM 503b notifies the controller 501a that the storing process is completed. Then, in S218 the controller 501a sends the data to the processor core requesting the data in the group of processor cores 500.

In the present embodiment, the data evicted from the L2 cache 503 is stored in the L2 cache in the cluster 60 which is Home. Therefore, when the group of processor cores 500 in the cluster 50 which is Local requests the data again, cache miss occurs in the L2 cache 503. However, cache hit occurs in the L2 cache 603. Thus, unlike the comparative example, processes for accessing to the memory 602 and acquiring the data from the memory 602 are not performed in the present embodiment. As a result, the group of processor cores 500 in the cluster 50 which is Local can acquire the requested data more quickly. That is, latency related to data acquisition from Remote clusters can be reduced in the information processing apparatus 2.

Furthermore, since the groups of processor cores 600 and 700 in the clusters 60 and 70 are in the non-operating state, the L2 caches 603 and 703 in the clusters 60 and 70 can be used as Victim Caches for the L2 cache 503 in the cluster 50. This means that the memory capacity for the L2 cache 503 increases by the capacity of the L2 caches 603 and 703 in the clusters 60 and 70 which are Home. Therefore, when an application is executed using a memory space exceeding the memory capacity of the memory 502 for example, latency related to data acquisition from Remote clusters can be advantageously reduced.

In the above comparative example, the groups of processor cores in the clusters which are Remote and Home in addition to the Local clusters are in the operating state. Therefore, the L2 caches in the Local clusters exchange data with other clusters. Thus, when data requested from a Remote cluster is stored in an L2 cache in a Local cluster, the capacity of the L2 cache is substantively reduced for the Local cluster. Further, in the administration of data in the L2 cache, determination criteria and controls are more complicated partially because it is determined which data from which cluster is preferentially acquired or stored in the L2 cache. As a result, the configurations in the comparative example can lead to larger cost-related overhead and performance-related overhead in comparison with the configurations in the present embodiment. Moreover, the data administration involves for example storing additional information indicating from which cluster each data is evicted in the comparative example. To the contrary, the administration of such additional information is not involved in the present embodiment.

Additionally, when data to be evicted is clean, a Local cluster notifies a Flush Back request to a Home cluster and does not send the data to the Home cluster in the comparative example. On the other hand, a Local cluster sends a Flush Back and data to be evicted to a Home cluster in the present embodiment. In addition, when the control circuits as illustrated in FIGS. 16 and 17 are employed in the present embodiment, the Local cluster can store both clean data and dirty data in the L2 cache in the Home cluster in case that the Local cluster evicts the clean data or the dirty data from the L2 cache. Thus, when the Local cluster acquires the data which has been evicted once, the Local cluster can effectively retrieve the data without access to the main memory.

Besides, common rules can be applied to both cases in which the operation mode of the group of processor cores is “mode on” and “mode off” for the protocols used for the cache coherence control. For example, it is assumed here that the MESI protocol employing the four states, Modified, Exclusive, Shared and Invalid, is used when the operation mode of the group of processor cores is “mode on”. In this case, this MESI protocol can be used without defining a new state when the operation mode of the group of processor cores is “mode off”. In addition, the control processes can be modified for the “mode on” mode and the “mode off” mode accordingly. Therefore, workload can be reduced when the configurations according to the present embodiment are applied to the configurations according to the comparative example.

Although the present embodiment is described as above, the configurations and the processes of the information processing apparatus are not limited to those as described above and various variations may be made to the embodiment described herein within the technical scope of the present invention. For example, as for switching between “mode on” and “mode off”, the operation mode can be set to “mode on” when an application is executed using a large amount of memory space exceeding the capacity of a main memory in a cluster. Therefore, the operation mode is set to “mode off” when an application is executed using memory space which does not exceed the capacity of the main memory in the cluster. Thus, appropriate configurations of memories and L2 caches can be employed flexibly for each application in the information processing apparatus. Moreover, efforts for establishing configurations of memories and L2 caches for each application can be omitted.

In addition, when the power supply for the group of processor cores is individually controlled for each cluster, the group of processor cores which is set in the non-operating state when the operation mode is set to “mode on” can be turned off. Therefore, unnecessary electricity consumption can be reduced in the information processing apparatus. It is noted that so-called power gating can be employed to control the power supply to each group of processor cores in the above embodiment.

The above descriptions exemplify a case in which the configurations of the control circuit in the controller 601a is modified as illustrated in FIG. 21. However, as another modification, while the configurations of the circuit in the controller 601a are not changed, the configurations of the circuit in the controller 501a can be changed. FIG. 24 illustrates such a modification.

The circuit in the controller 501a as illustrated in FIG. 24 is a control circuit used when the operation mode of the cluster 50 is “mode on and processor cores operating”. In FIG. 24, RequestIsSharedDataRequest, which means that not an exclusive data acquisition request but a data acquisition request which enables sharing data with other clusters is performed, and RequestIsExclusiveDataRequest, which means that an exclusive data acquisition request is performed, are signals for signals for instructing operations and the other signals are flag signals. It is noted that a data acquisition request which enables sharing data with other clusters and an exclusive data acquisition request are examples of data acquisition requests in the present embodiment.

As illustrated in FIG. 24, an AND gate 501h outputs “1” when the operation mode of the cluster 50 is “mode on and processor cores operating” and data acquisition is performed to another cluster. In other cases, the AND gate 501h outputs “0”. An OR gate 501i outputs an instruction signal (RequestIsExclusiveDataRequest2) for performing an exclusive data acquisition request when the AND gate 501h outputs “1” or an exclusive data acquisition request is performed according to the comparative example. In addition, the output from the AND gate 501h is inverted by the inverter 501j and input into the AND gate 501k.

When the operation mode of the cluster 50 is “mode on and processor cores operating” and the cluster 50 requests data acquisition to another cluster, the AND gate 501k blocks a data acquisition request which enables sharing data with other clusters (RequestIsSharedDataRequest2) from the cluster 50 which is Local. On the other hand, when the operation mode of the cluster 50 is “mode off” or “processor cores non-operating” or when the cluster 50 does not request data acquisition to another cluster, the processes are performed as described in the comparative example (“RequestIsSharedDataRequest in comparative example” and “RequestIsExclusiveDataRequest in comparative example” in FIG. 22). Since circuits subsequent to the OR gate 501i and the AND gate 501k and circuits in the controller 601a are conventional circuits, the detailed descriptions and drawings of the circuits are omitted here.

When the controller 501a in the cluster 50 notifies an exclusive data acquisition request to the controller 601a in the cluster 60 according to the control circuit as illustrated in FIG. 24, the controller 601a acquires the requested data from the data RAM 603b. And the controller 601a sends the acquired data to the controller 501a. In addition, since the data acquisition request from the controller 501a is an exclusive data acquisition request, the controller 601a discards the data from the data RAM 603b.

Thus, since the control circuit as illustrated in FIG. 21 operates in a conventional manner when the cluster is Local, workload for operational modifications can be omitted. Similarly, since the control circuit as illustrated in FIG. 24 operates in a conventional manner when the cluster is Home, workload for operational modifications can be omitted. It can be arbitrarily determined which control circuit is employed.

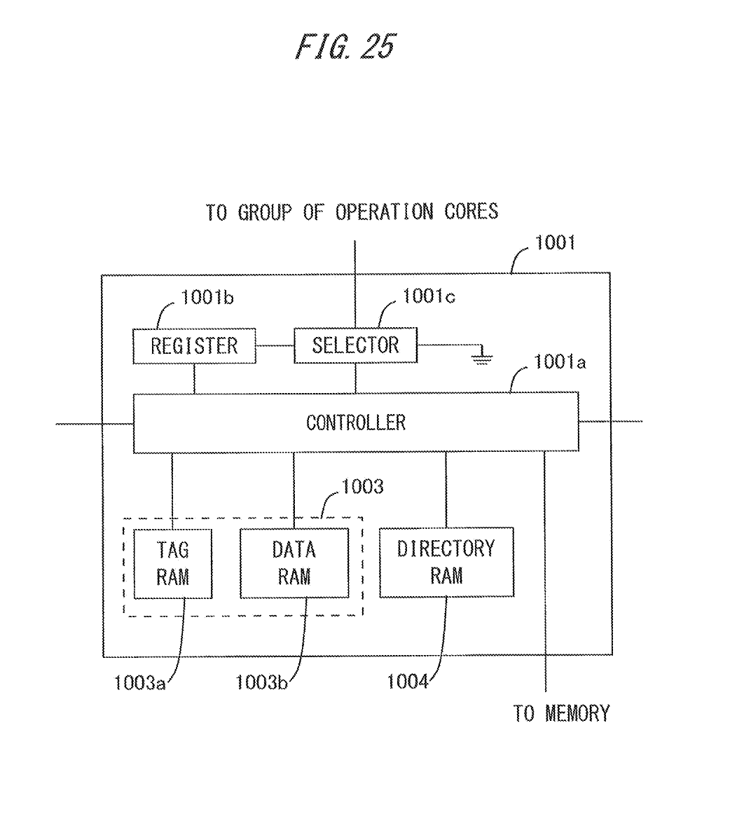

Moreover, in the above descriptions, a register is employed to set a group of processor cores to operating state or non-operating state. Instead of the configurations of the L2 cache control unit as described in the above embodiment, configurations as illustrated in FIG. 25 can be employed to set a group of processor cores to operating state or non-operating state. As illustrated in FIG. 25, an L2 cache control unit 1001 includes a controller 1001a, a register 1001b, a selector 1001c and an L2 cache 1003. In addition, the L2 cache 1003 includes a tag RAM 1003a, a data RAM 1003b and a directory RAM 1004. In the L2 cache control unit 1001, the selector 1001c refers to a setting value of the register 1001b to determine whether requests from the group of processor cores in the cluster, which are not depicted, are blocked or not. For example, when the setting value of the register 1001b is “ON”, the selector 1001c blocks requests from the group of processor cores in the cluster. That is, the group of processor cores can be substantially set to the non-operating state. Further, when the setting value of the register 1001b is “OFF”, the selector 1001c sends requests from the group of processor cores to the controller 1001a. That is, the group of processor cores can be substantially set to the operating state. A configuration in which an application is executed outside of a group of clusters to control the operation mode of each cluster in the group can also be employed in the above embodiment.

<<Computer Readable Recording Medium>>

It is possible to record a program which causes a computer to implement any of the functions described above on a computer readable recording medium. Here, the functions include setting of a register for example. In addition, by causing the computer to read in the program from the recording medium and execute it, the function thereof can be provided. Here, the computer includes clusters and controllers for example.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

An operation processing apparatus, an information processing apparatus and a method of controlling an information processing apparatus according to one embodiment may reduce the access frequency to a main memory.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An operation processing apparatus connected with another operation processing apparatus, comprising:
an operation processing unit configured to perform an operation process using first data administered by the own operation processing apparatus and second data administered by another operation processing apparatus and acquired from another operation processing apparatus; and
a control unit configured to include a setting unit which sets the operation processing unit to an operating state or a non-operating state and a cache memory which holds the first data and the second data, wherein when the setting unit sets the operation processing unit to the operating state and the second data is evicted from the cache memory, the control unit sends to another operation processing apparatus the evicted data and a request which is a trigger for storing the evicted data in a cache memory in another operation processing apparatus.

2. The operation processing apparatus according to claim 1, wherein when the setting unit sets the operation processing unit to the operating state the control unit sends to another operation processing apparatus a request that data be sent to the operation processing apparatus including the control unit and that the data be discarded from the cache memory in another operation processing apparatus.

3. An operation processing apparatus connected with another operation processing apparatus, comprising:
an operation processing unit configured to perform an operation process using third data administered by the own operation processing apparatus and fourth data administered by another operation processing apparatus and acquired from another operation processing apparatus;
a control unit configured to include a setting unit which sets the operation processing unit to an operating state or a non-operating state and a cache memory which holds the third data and the fourth data, wherein the control unit stores the third data in the cache memory when the setting unit sets the operation processing unit to the non-operating state and the control unit receives the third data and a Write Back request or the third data and a Flush Back request from another operation processing apparatus.

4. The operation processing apparatus according to claim 3, wherein when the setting unit sets the operation processing unit to the non-operating state and the control unit receives a data acquisition request for the third data stored in the cache memory from another operation processing apparatus, the control unit sends the third data to another operation processing apparatus and discards the third data from the cache memory.

5. An information processing apparatus including an operation processing apparatus connected with another operation processing apparatus, wherein
the operation processing apparatus includes:
an operation processing unit configured to perform an operation process using fifth data administered by the own operation processing apparatus and sixth data administered by another operation processing apparatus and acquired from another operation processing apparatus, and
a control unit configured to include a setting unit which sets the operation processing unit to an operating state or a non-operating state and a cache memory which holds the fifth data and the sixth data, wherein when the setting unit sets the operation processing unit to the operating state and the sixth data is evicted from the cache memory, the control unit sends to another operation processing apparatus the evicted data and a request which is a trigger for storing the evicted data in a cache memory in another operation processing apparatus.

6. The information processing apparatus according to claim 5, wherein when the setting unit sets the operation processing unit to the operating state the control unit sends to another operation processing apparatus a request that data be sent to the operation processing apparatus including the control unit and that the data be discarded from the cache memory in another operation processing apparatus.

7. An information processing apparatus including an operation processing apparatus connected with another operation processing apparatus, wherein
the operation processing apparatus includes:
an operation processing unit configured to perform an operation process using seventh data administered by the own operation processing apparatus and eighth data administered by another operation processing apparatus and acquired from another operation processing apparatus;
a control unit configured to include a setting unit which sets the operation processing unit to an operating state or a non-operating state and a cache memory which holds the seventh data and the eighth data, wherein the control unit stores the seventh data in the cache memory when the setting unit sets the operation processing unit to the non-operating state and the control unit receives the seventh data and a Write Back request or the seventh data and a Flush Back request from another operation processing apparatus.

8. The information processing apparatus according to claim 7, wherein when the setting unit sets the operation processing unit to the non-operating state and the control unit receives a data acquisition request for the seventh data stored in the cache memory from another operation processing apparatus, the control unit sends the seventh data to another operation processing apparatus and discards the seventh data from the cache memory.

9. The information processing apparatus according to claim 5, wherein
a group is formed so as to include an operation processing apparatus in which an operation processing unit is set to the operating state by a setting unit and an operation processing apparatus in which an operation processing unit is set to the non-operating state by a setting unit, and
an operation processing apparatus outside of the group accesses to the operation processing apparatus in which the operation processing unit is set to the operating state by the setting unit and does not access to the operation processing apparatus in which the operation processing unit is set to the non-operating state by the setting unit.

10. A method of controlling an information processing apparatus, the method comprising:
setting by a processor an operation processing unit of a first operation processing apparatus included in the information processing apparatus to an operating state, the operation processing unit performing an operation process using ninth data administered by the first operation processing apparatus and tenth data administered by a second operation processing apparatus connected with the first operation processing apparatus and acquired from the second operation processing apparatus; and
sending by a processor, when the tenth data is evicted from a cache memory of the first operation processing apparatus, the evicted data and a request which is a trigger for storing the evicted data in a cache memory of the second operation processing apparatus to the second operation processing apparatus.

11. The method of controlling the information processing apparatus according to claim 10, wherein a request that data be sent to the first operation processing apparatus and that the data be discarded from the cache memory in the second operation processing apparatus is sent to the second operation processing apparatus.

12. A method of controlling an information processing apparatus, the method comprising:
setting by a processor an operation processing unit of a third operation processing apparatus included in the information processing apparatus to a non-operating state, the operation processing unit performing an operation process using eleventh data administered by the third operation processing apparatus and twelfth data administered by a fourth operation processing apparatus connected with the third operation processing apparatus and acquired from the fourth operation processing apparatus; and
storing by a processor, when the third operation processing apparatus receives the eleventh data and a Write Back request or the eleventh data and a Flush Back request from the fourth operation processing apparatus, the eleventh data in a cache memory of the third operation processing apparatus.

13. The method of controlling the information processing apparatus according to claim 12, wherein when the third operation processing apparatus receives a data acquisition request for the eleventh data stored in the cache memory from the fourth operation processing apparatus, the eleventh data is sent to the fourth operation processing apparatus and the eleventh data is discarded from the cache memory.
